(19) United States
(12) Patent Application Publication
(10) Pub. No.: US 2022/0362777 A1
(43) Pub. Date: Nov. 17, 2022

(54) CHANNEL DEVICE

(71) Applicant: KABUSHIKI KAISHA KOBE SEIKO SHO (KOBE STEEL, LTD.), Hyogo (JP)

(72) Inventors: Akira MATSUOKA, Kobe-shi (JP); Koji NOISHIKI, Takasago-shi (JP); Nobumasa ICHIHASHI, Takasago-shi (JP)

(73) Assignee: KABUSHIKI KAISHA KOBE SEIKO SHO (KOBE STEEL, LTD.), Hyogo (JP)

(21) Appl. No.: 17/659,793

(22) Filed: Apr. 19, 2022

(30) Foreign Application Priority Data
May 13, 2021 (JP) 2021-081871

(51) Int. Cl. B01L 3/00

(52) U.S. Cl. CPC B01L 3/502784; B01L 2200/12; B01L 2300/0874; B01L 2400/0475

(57) ABSTRACT

In a channel structure of a channel device, first confluence channels of a plurality of first channels include a plurality of first confluence channels arranged along a second board front surface, first confluence portions of the first channels in each of first boards are configured of a plurality of first confluence portion through-holes that penetrate the first board, and second first-liquid introduction channel and second second-liquid introduction channels of a plurality of second channels are arranged along the second board front surface and are located in an area that is deviated from the first confluence channels in a view in a direction along a stacking direction of the first board and the second board.

### FIELD OF THE INVENTION

The present invention relates to a channel device.

### BACKGROUND ART

A channel device having a plurality of microchannels therein has been known. As an example of such a channel device, Japanese Patent No. 5212313 discloses an emulsifying microfluid device for obtaining an emulsion.

The emulsifying microfluid device disclosed in Japanese Patent No. 5212313 includes a stack of four structures, i.e., a liquid introduction unit, a dispersed phase distribution unit, a continuous phase distribution unit, and a liquid discharge unit that are stacked on each other.

The liquid introduction unit includes a continuous phase port into which a liquid of a continuous phase is introduced, a continuous phase supply port that is connected to the continuous phase port and that discharges the liquid of the continuous phase to the dispersed phase distribution unit one layer above the continuous phase supply port, a dispersed phase port into which a liquid of a dispersed phase is introduced, and a dispersed phase supply port that is connected to the dispersed phase port and that discharges the liquid of the dispersed phase to the dispersed phase distribution unit one layer above the dispersed phase supply port.

The dispersed phase distribution unit has a lower surface in contact with the liquid introduction unit, and has a dispersed phase main channel of a meandering shape that is formed on the lower surface. The dispersed phase main channel is connected to the dispersed phase supply port. The liquid of the dispersed phase discharged from the dispersed phase supply port flows into the dispersed phase main channel and flows therethrough. The dispersed phase distribution unit has a plurality of dispersed phase processing channels arranged at intervals along the dispersed phase main channel. The dispersed phase processing channels are fine openings extending from the dispersed phase main channel to an upper surface of the dispersed phase distribution unit. The dispersed phase distribution unit has a continuous phase passage port connected to the continuous phase supply port. The continuous phase passage port vertically penetrates the dispersed phase distribution unit.

The continuous phase distribution unit has a continuous phase main channel of a meandering shape that is on a lower surface in contact with the dispersed phase distribution unit. The continuous phase main channel is connected to the continuous phase passage port. A liquid of a continuous phase discharged from the continuous phase supply port and having passed through the continuous phase passage port flows into the continuous phase main channel and flows therethrough. The continuous phase main channel has two channel portions that are arranged so as to sandwich the dispersed phase processing channel in a horizontal direction perpendicular to a vertical direction and that extends parallel with each other. The continuous phase distribution unit has a plurality of fine continuous phase processing channels that connect the two channel portions and that communicate with the dispersed phase processing channels, respectively. The liquid of the dispersed phase flowing from each of the dispersed phase processing channels joins the liquid of the continuous phase flowing from the continuous phase main channel into each of the continuous phase processing channels. The continuous phase distribution unit has a plurality of fine droplet generating channels each extending from each of the continuous phase processing channels to an upper surface of the continuous phase distribution unit, each droplet generating channel extending right above each dispersed phase processing channels. The liquid of the continuous phase and the liquid of the dispersed phase, which have joined together to become a state of a sheath flow, flow into each of the droplet generating channels, in which droplets of a dispersed phase are formed. As a result, an emulsion composed of the droplets of the dispersed phase and the liquid of the continuous phase is created.

The liquid discharge unit has an emulsion main channel of a meandering shape that is on a lower surface in contact with the continuous phase distribution unit. The emulsion main channel is connected to the droplet generating channels. To this emulsion main channel, the emulsions from the droplet generating channels, the emulsions being created respectively in the droplet generating channels, flow in. The emulsions flowing into the emulsion main channel merge together there, and are discharged from the emulsion main channel.

According to the microfluid device disclosed in Japanese Patent No. 5212313, a large number of dispersed phase processing channels are provided along the dispersed phase channel in order to increase the number of places where the liquid of the dispersed phase join the liquid of the continuous phase. In this configuration, however, to avoid a case where the flow rate of the liquid of the dispersed phase that flows through the dispersed phase processing channels into the continuous phase processing channels changes between the upstream side and the downstream side of the dispersed phase channel, the diameter of each dispersed phase processing channel needs to be made significantly smaller than the diameter of the dispersed phase channel. Such a configuration raises a concern that a foreign substance mixed into the liquid of the dispersed phase may block the dispersed phase processing channel. Adopting such a configuration is, therefore, not preferable.

To increase the number of places where a first liquid and a second liquid join to increase the amount of an interaction process between the first liquid and the second liquid while avoiding the above blockage, for example, the following stacked channel structure may be adopted, in which a first board is provided with a plurality of confluence portions penetrating the first board from its front surface to back surface, a plurality of first introduction channels, into which the first liquid is introduced, and a plurality of second introduction channels, into which the second liquid is introduced, are arranged along the front surface of the first board such that the first and second introduction channels are connected to the corresponding confluence portions, respectively, and along the front surface of another board, i.e., a second board joined to the back surface of the first board, a plurality of confluence channels, in each of which a liquid mixture of the first liquid and the second liquid joined at each confluence portion flows, are arranged such that the confluence channels are connected to the corresponding confluence portions, respectively. In the stacked channel structure, stacks of these two boards are layered repeatedly.

In this case, however, arrangement of the confluence channels along the front surface of the second board is restricted by arrangement of the confluence portions on the first board. This arrangement restriction creates an unnecessary space in an area along the front surface of the second board, the unnecessary space being a space where no channel can be arranged. This raises a problem that a channel capacity per unit volume of the channel structure drops.

### SUMMARY OF THE INVENTION

An object of the present invention is to provide a channel device that solves the above problem.

Another object of the present invention is to provide a channel device that even when arrangement of a plurality of confluence portions in a channel structure restricts arrangement of confluence channels connected to the confluence portions, can increase a channel capacity per unit volume of the channel structure.

According to one aspect of the present invention, the channel device includes a plurality of first channels and a plurality of second channels that allow a first liquid and a second liquid to join and flow through the first and second channels, respectively. The channel device includes a channel structure having therein the plurality of the first channels and the plurality of the second channels. Each of the plurality of the first channels includes: a first first-liquid introduction channel into which the first liquid is introduced; a first second-liquid introduction channel into which the second liquid is introduced; a first confluence portion connected to both a downstream end of the first first-liquid introduction channel and a downstream end of the first second-liquid introduction channel to cause the first liquid flowing through the first first-liquid introduction channel and the second liquid flowing through the first second-liquid introduction channel to join together; and a first confluence channel connected to the first confluence portion on a downstream side of the first confluence portion to allow a liquid mixture of the first liquid and the second liquid having joined at the first confluence portion to flow through the first confluence channel. Each of the plurality of the second channels includes: a second first-liquid introduction channel into which the first liquid is introduced; a second second-liquid introduction channel into which the second liquid is introduced; a second confluence portion connected to both a downstream end of the second first-liquid introduction channel and a downstream end of the second second-liquid introduction channel to cause the first liquid flowing through the second first-liquid introduction channel and the second liquid flowing through the second second-liquid introduction channel to join together; and a second confluence channel connected to the second confluence portion on a downstream side of the second confluence portion to allow a liquid mixture of the first liquid and the second liquid having joined at the second confluence portion to flow through the second confluence channel. The channel structure includes a plurality of first boards and a plurality of second boards, and the first board and the second board are stacked alternately along a thickness direction of each of the first board and the second board. Each of the plurality of the first boards has a first board front surface and a first board back surface, and the first board front surface is one surface of the first board in the thickness direction of the first board while the first board back surface is the other surface opposite to the first board front surface. Each of the plurality of the second boards has a second board front surface and a second board back surface, and the second board front surface is one surface of the second board in the thickness direction of the second board, the one surface being in close contact with the first board back surface of the first board stacked on the second board, while the second board back surface is the other surface opposite to the second board front surface, the other surface being in close contact with the first board front surface of the first board on which the second board is stacked. The first first-liquid introduction channels of the plurality of the first channels include a plurality of the first first-liquid introduction channels arranged along the first board front surface of each of the plurality of the first boards. The first second-liquid introduction channels of the plurality of the first channels include a plurality of the first second-liquid introduction channels arranged along the first board front surface of each of the plurality of the first boards. The first confluence channels of the plurality of the first channels include a plurality of the first confluence channels arranged along the second board front surface of each of the plurality of the second boards. The first confluence portions of the plurality of the first channels in each of the first boards are configured of a plurality of first confluence portion through-holes that penetrate the first board in the thickness direction of the first board. The second first-liquid introduction channels of the plurality of the second channels and the second second-liquid introduction channels of the plurality of the second channels are arranged along the second board front surface of each of the plurality of the second boards, and are located in an area that is deviated from the plurality of the first confluence channels in a view in a direction along a stacking direction of the first board and the second board.

### BRIEF DESCRIPTION OF THE DRAWINGS

FIG. 1 is a perspective view of a channel device according to an embodiment of the present invention;

FIG. 2 is an exploded view of a channel structure of the channel device according to the embodiment of the present invention;

FIG. 3 depicts arrangement of first channels and second channels, the arrangement being observed when a first board and a second board stacked on each other in a channel structure according to the embodiment of the present invention are viewed along a stacking direction of the first board and the second board;

FIG. 4 is a plan view of the first board constituting the channel structure according to the embodiment of the present invention, showing a first board front surface of the first board;

FIG. 5 is a plan view of the second board constituting the channel structure according to the embodiment of the present invention, showing a second board front surface of the second board;

FIG. 6 is a cross-sectional view of the first board and the second board stacked on each other, the cross-sectional view being taken along a VI-VI line in FIG. 3;

FIG. 7 is a cross-sectional view of the first board and the second board stacked on each other, the cross-sectional view being taken along a VII-VII line in FIG. 3;

FIG. 8 depicts arrangement of the first channels and the second channels, the arrangement being observed when the first board and the second board stacked on each other in a channel structure according to a comparative example of the present invention are viewed along the stacking direction of the first board and the second board;

FIG. 9 is a plan view of the first board constituting the channel structure according to the comparative example, showing the first board front surface of the first board;

FIG. 10 is a plan view of the second board constituting the channel structure according to the comparative example of the present invention, showing the second board front surface of the second board;

FIG. 11 depicts arrangement of the first channels and the second channels, the arrangement being observed when the first board and the second board stacked on each other in a channel structure according to a first modification of the present invention are viewed along the stacking direction of the first board and the second board;

FIG. 12 is a plan view of the first board constituting the channel structure according to the first modification, showing the first board front surface of the first board;

FIG. 13 is a plan view of the second board constituting the channel structure according to the first modification of the present invention, showing the second board front surface of the second board;

FIG. 14 is an exploded view of a channel structure according to a second modification of the present invention; and

FIG. 15 is a plan view of the second first board among a plurality of the first boards stacked in the stacking direction of the first boards and the second boards in the second modification, showing the first board front surface of the second first board.

### DESCRIPTION OF EMBODIMENTS

Embodiments of the present invention will now be described with reference to the drawings.

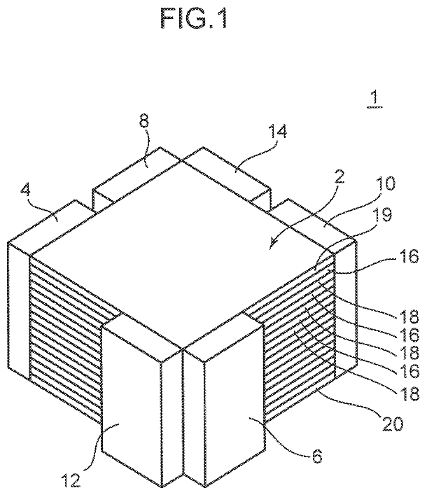

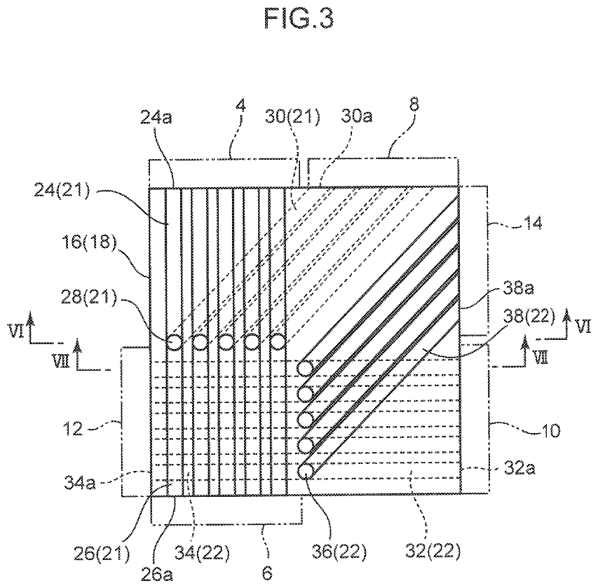

FIG. 1 is a perspective view of a channel device 1 according to an embodiment of the present invention. The channel device 1 according to this embodiment includes a plurality of first channels 21 (see FIG. 3) and a plurality of second channels 22 (see FIG. 3) that cause a first liquid and a second liquid to join and flow through the first channels 21 and second channels 22. Each of the first channels 21 and of the second channels 22 is a microchannel having a minute channel diameter. The channel device 1 is used for various processes by which the first liquid and the second liquid are caused to join and interact with each other. For example, the channel device 1 is used for a process by which the first liquid of a continuous phase and a second liquid of a dispersed phase are caused to join and generate an emulsion, a process by which the first liquid and the second liquid that can chemically react with each other are caused to join and chemically react with each other, or an extraction process by which the first liquid containing an extraction target substance and the second liquid serving as an extractant are caused to join to extract the extraction target substance from the first liquid and cause the extraction target substance to migrate into the second liquid.

As shown in FIG. 3, each of the first channels 21 includes a first first-liquid introduction channel 24, a first second-liquid introduction channel 26, a first confluence portion 28, and a first confluence channel 30.

The first first-liquid introduction channel 24 is a channel part into which the first liquid is distributed and introduced. The first first-liquid introduction channel 24 has a first first-liquid inlet 24a located on an upstream end of the first first-liquid introduction channel 24. The first first-liquid inlet 24a allows the first liquid to flow into first first-liquid introduction channel 24 through the first first-liquid inlet 24a.

The first second-liquid introduction channel 26 is a channel part into which the second liquid is distributed and introduced. The first second-liquid introduction channel 26 has a first second-liquid inlet 26a located on an upstream end of the first second-liquid introduction channel 26. The first second-liquid inlet 26a allows the second liquid to flow into first second-liquid introduction channel 26 through the first second-liquid inlet 26a.

The first confluence portion 28 causes the first liquid flowing through the first first-liquid introduction channel 24 and the second liquid flowing through the first second-liquid introduction channel 26 to join together. The first confluence portion 28 is connected to a downstream end of the first first-liquid introduction channel 24 and to a downstream end of the first second-liquid introduction channel 26 so that the first liquid from the downstream end of the first first-liquid introduction channel 24 and the second liquid from the downstream end of the first second-liquid introduction channel 26 both flow into the first confluence portion 28.

The first confluence channel 30 is a channel part where a liquid mixture of the first liquid and the second liquid having joined at the first confluence portion 28 flows. The first confluence channel 30 is connected to the downstream side of the first confluence portion 28. In the first confluence channel 30, an interaction process between the first liquid and the second liquid in the liquid mixture is carried out as the liquid mixture flows downstream. The first confluence channel 30 has a first outlet 30a which is located on a downstream end of the first confluence channel 30 and from which the liquid mixture flows out.

As shown in FIG. 3, each of the second channels 22 includes a second first-liquid introduction channel 32, a second second-liquid introduction channel 34, a second confluence portion 36, and a second confluence channel 38.

The second first-liquid introduction channel 32 is a channel part into which the first liquid is distributed and introduced. The second first-liquid introduction channel 32 has a second first-liquid inlet 32a located on an upstream end of the second first-liquid introduction channel 32 The second first-liquid inlet 32a allows the first liquid to flow into second first-liquid introduction channel 32 through the second first-liquid inlet 32a.

The second second-liquid introduction channel 34 is a channel part into which the second liquid is distributed and introduced. The second second-liquid introduction channel 34 has a second second-liquid inlet 34a located on an upstream end of the second second-liquid introduction channel 34. The second second-liquid inlet 34a allows the second liquid to flow into the second second-liquid introduction channel 34 through the second second-liquid inlet 34a.

The second confluence portion 36 causes the first liquid flowing through the second first-liquid introduction channel 32 and the second liquid flowing through the second second-liquid introduction channel 34 to join together. The second confluence portion 36 is connected to a downstream end of the second first-liquid introduction channel 32 and to a downstream end of the second second-liquid introduction channel 34 so that the first liquid from the downstream end of the second first-liquid introduction channel 32 and the second liquid from the downstream end of the second second-liquid introduction channel 34 both flow into the second confluence portion 36.

The second confluence channel 38 is a channel part where a liquid mixture of the first liquid and the second liquid having joined at the second confluence portion 36 flows. The second confluence channel 38 is connected to the downstream side of the second confluence portion 36. In the second confluence channel 38, an interaction process between the first liquid and the second liquid in the liquid mixture is carried out as the liquid mixture flows downstream. The second confluence channel 38 has a second outlet 38a which is located on a downstream end of the second confluence channel 38 and from which the liquid mixture flows out.

As shown in FIG. 1, the channel device 1 according to this embodiment includes a channel structure 2, a first first-liquid distribution header 4, a first second-liquid distribution header 6, a first recovery header 8, a second first-liquid distribution header 10, a second second-liquid distribution header 12, and a second recovery header 14.

The channel structure 2 is a block-shaped (rectangular parallelepiped) structure in which the first channels 21 and the second channels 22 are provided. The channel structure 2 includes a plurality of first boards 16, a plurality of second boards 18, and a sealing board 19 which are stacked on each other.

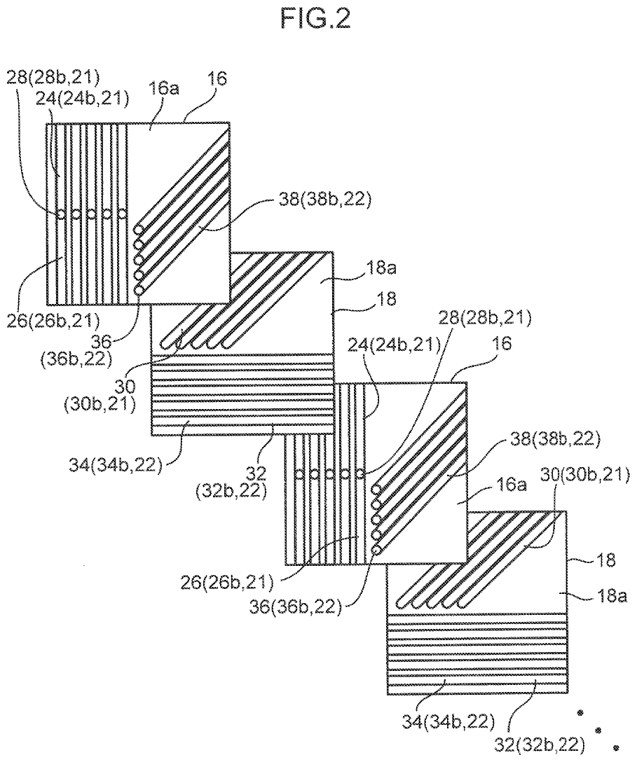

As shown in FIGS. 1 and 2, the first boards 16 and the second boards 18 are stacked alternately in a direction along the thickness direction of the first and second boards 16 and 18. The sealing board 19 is stacked on the first board 16 disposed at one end in the above stacking direction. The first boards 16, the second boards 18, and the sealing board 19 are stacked together such that their mutually contacting surfaces are kept in close contact with each other. This gives these boards an integral structure. Thus, the first boards 16, the second boards 18, and the sealing board 19, which are stacked into the integral structure, form the channel structure 2.

Various methods are adopted to bring the mutually contacting surfaces of the first boards 16, the second boards 18, and the sealing board 19 into close contact with each other. The methods include, for example, a method of bringing the surfaces into close contact with each other by diffusion bonding, a method of joining the surfaces together by sintering to bring the surfaces into close contact with each other, a method of bonding the surfaces together by an adhesive to bring the surfaces into close contact with each other, and a method according to which the channel device 1 includes a pressing tool (not illustrated) that presses the first boards 16, the second boards 18, and the sealing board 19 stacked on each other from both sides in the stacking direction, and brings the surfaces into close contact with each other by a press applied by the pressing tool. When the surfaces are brought into close contact with each other by a press applied thereto, the surfaces may be brought into close contact with each other with gaskets disposed on the peripheral edges of the surfaces being sandwiched between the surfaces to enhance sealing performance between the surfaces.

Each first board 16 includes the first first-liquid introduction channels 24, the first second-liquid introduction channels 26, and the first confluence portions 28 of the first channels 21, and the second confluence portions 36 and the second confluence channels 38 of the second channels 22.

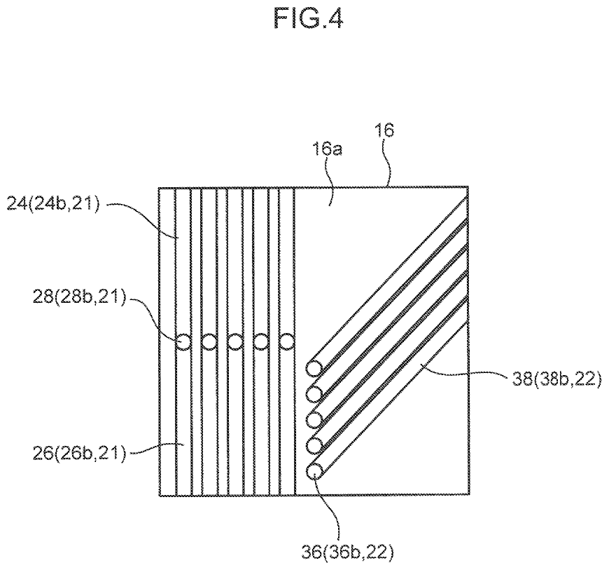

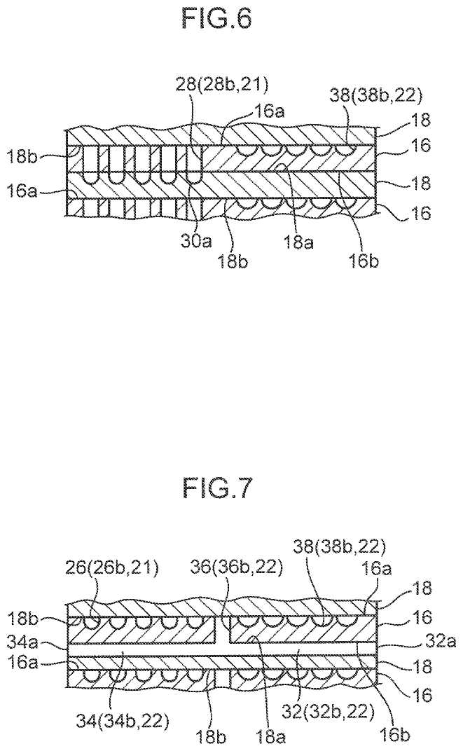

Specifically, each first board 16 (see FIG. 4) has a rectangular shape in a view in a direction along the thickness direction of the first board 16. Each first board 16 has a first board front surface 16a, which is a surface facing one side in the direction along the thickness direction of the first board 16, and a first board back surface 16b (see FIGS. 6 and 7), which is a surface facing the side opposite to the first board front surface 16a. Each first board front surface 16a (see FIG. 4) includes a plurality of first first-liquid introduction grooves 24b, a plurality of first second-liquid introduction grooves 26b, and a plurality of second channel confluence grooves 38b. The first first-liquid introduction grooves 24b constitute the first first-liquid introduction channels 24. The first second-liquid introduction grooves 26b constitute the first second-liquid introduction channels 26. The second channel confluence grooves 38b constitute the second confluence channels 38. Each first board 16 includes a plurality of first confluence portion through-holes 28b (see FIGS. 4 and 6) and a plurality of second confluence portion through-holes 36b (see FIGS. 4 and 7) that are formed so as to penetrate the first board 16 in its thickness direction, from the first board front surface 16a to the first board back surface. The first confluence portion through-holes 28b constitute the first confluence portions 28. The second confluence portion through-holes 36b constitute the second confluence portions 36.

Each of the first first-liquid introduction grooves 24b linearly extends from one side of the rectangular first board front surface 16a in a direction perpendicular to the one side, and reaches a central part of the first board 16 in the direction. These first first-liquid introduction grooves 24b are arranged adjacent and parallel to each other in a row.

Each of the first second-liquid introduction grooves 26b linearly extends from a side opposite to the one side of the first board front surface 16a in a direction perpendicular to the side, and reaches a central part of the first board 16 in the direction. These first second-liquid introduction grooves 26b are arranged adjacent and parallel to each other in a row. Each first second-liquid introduction groove 26b is disposed on an extension line of the corresponding first first-liquid introduction groove 24b, and extends in the same direction in which the first first-liquid introduction groove 24b extends. The first first-liquid introduction grooves 24b and the first second-liquid introduction grooves 26b are located in a half area of the first board front surface 16a in a direction perpendicular to the direction of extension of the first first-liquid introduction grooves 24b and first second-liquid introduction grooves 26b.

The first confluence portion through-holes 28b are arranged respectively on parts where the first first-liquid introduction grooves 24b and the first second-liquid introduction grooves 26b corresponding thereto are connected to each other. Each first confluence portion through-hole 28b is a circular hole. Each first confluence portion through-hole 28b has a hole diameter equal to the width of the first first-liquid introduction channel 24, the width being perpendicular to the extending direction of the first first-liquid introduction channel 24, and to the width of the first second-liquid introduction channel 26, the width being perpendicular to the extending direction of the first second-liquid introduction channel 26. In other words, each first confluence portion through-hole 28b has a hole diameter equal to the width of the first first-liquid introduction groove 24b, the width being perpendicular to the extending direction of the first first-liquid introduction groove 24b, and to the width of the first second-liquid introduction groove 26b, the width being perpendicular to the extending direction of the first second-liquid introduction groove 26b.

The second channel confluence grooves 38b are located in the other half area of the first board front surface 16a that is different from the half area in which the first first-liquid introduction grooves 24b and the first second-liquid introduction grooves 26b are arranged. The first board front surface 16a of the rectangular shape has two sides perpendicular to the other two sides of the first board front surface 16a, the other two sides being provided with one ends of the first first-liquid introduction grooves 24b and with one ends of the first second-liquid introduction grooves 26b, respectively. The second channel confluence grooves 38b extend diagonally from one of the other two sides that is in the area where the first first-liquid introduction grooves 24b and the first second-liquid introduction grooves 26b are not arranged, relative to the direction of extension of the first first-liquid introduction grooves 24b and the first second-liquid introduction grooves 26b. These second channel confluence grooves 38b are arranged adjacent and parallel to each other in a row.

The second confluence portion through-holes 36b are provided respectively on parts of the first board 16 that correspond to respective ends of the second channel confluence grooves 38b. Each second confluence portion through-hole 36b is a circular hole. Each second confluence portion through-hole 36b has a hole diameter equal to the width of the second first-liquid introduction channel 32, the width being perpendicular to the extending direction of the second first-liquid introduction channel 32, and to the width of the second second-liquid introduction channel 34, the width being perpendicular to the extending direction of the second second-liquid introduction channel 34. In other words, each second confluence portion through-hole 36b has a hole diameter equal to the width of a second first-liquid introduction groove 32b that will be described later, the width being perpendicular to the extending direction of the second first-liquid introduction groove 32b, and to the width of a second second-liquid introduction groove 34b that will be described later, the width being perpendicular to the extending direction of the second second-liquid introduction groove 34b.

In a stacked structure formed of the first boards 16 and the second boards 18, the sealing board 19 is brought into close contact with the first board front surface 16a of the first board 16 disposed at one end in the stacking direction of the boards. The first board front surface 16a of the first board 16 disposed at the one end includes openings of the first first-liquid introduction grooves 24b, openings of the first second-liquid introduction grooves 26b, and openings of the second channel confluence grooves 38b, and these openings are sealed with the sealing board 19. The first board front surface 16a of each first board 16 disposed at a position different from the one end in the stacking direction also includes openings of the first first-liquid introduction grooves 24b, openings of the first second-liquid introduction grooves 26b, and openings of the second channel confluence grooves 38b, and these openings are sealed with the second board 18 in close contact with first board front surface 16a.

In the above manner, the first first-liquid introduction grooves 24b on each first board front surface 16a, the first first-liquid introduction grooves 24b having their openings sealed, faun the first first-liquid introduction channels 24 arranged on each first board front surface 16a. Likewise, the first second-liquid introduction grooves 26b on each first board front surface 16a, the first second-liquid introduction grooves 26b having their openings sealed, form the first second-liquid introduction channels 26 arranged on each first board front surface 16a. The first confluence portion through-holes 28b formed on each first board 16 form the first confluence portions 28 connected to the first first-liquid introduction channels 24 and the first second-liquid introduction channels 26 that are formed on the first board 16.

The second channel confluence grooves 38b on each first board front surface 16a, the second channel confluence grooves 38b having their openings sealed, form the second confluence channels 38 arranged on each first board front surface 16a. The second confluence portion through-holes 36b formed on each first board 16 form the second confluence portions 36 connected to upstream ends of the second confluence channels 38 formed on the first board 16. The second confluence channels 38 formed in this manner are arranged in an area that is deviated from the first first-liquid introduction channels 24, the first second-liquid introduction channels 26, and the first confluence portions 28 in a view in the direction along the stacking direction. In other words, in a view in the direction along the stacking direction, the second confluence channels 38 are arranged in an area different from the area where the first first-liquid introduction channels 24, the first second-liquid introduction channels 26, and the first confluence portions 28 are arranged.

The second confluence channels 38 arranged along each first board front surface 16a are configured such that respective flow rates per unit time of the liquid mixture in the second confluence channels 38 are equal. The second confluence channels 38 of all second channels 22 provided in the channel structure 2 are thus configured such that respective flow rates per unit time of the liquid mixture in the second confluence channels 38 are equal.

Each of the second confluence channels 38 arranged along each first board front surface 16a has a section perpendicular to the direction of flow of the liquid mixture in the second confluence channels 38. The shape of the section of each second confluence channel 38 is the same and therefore the area of the section of each second confluence channel 38 is the same. Thus, the section of each of the second confluence channels 38 of all second channels 22 provided in the channel structure 2, the section being perpendicular to the direction of flow of the liquid mixture, is the same in shape and in area as well. The channel length of each of the second confluence channels 38 arranged along each first board front surface 16a is also the same. Thus, the channel length of each of the second confluence channels 38 of all second channels 22 provided in the channel structure 2 is the same.

Each second board 18 includes first confluence channels 30 of the first channels 21, and the second first-liquid introduction channels 32 and second second-liquid introduction channels 34 of the second channels 22.

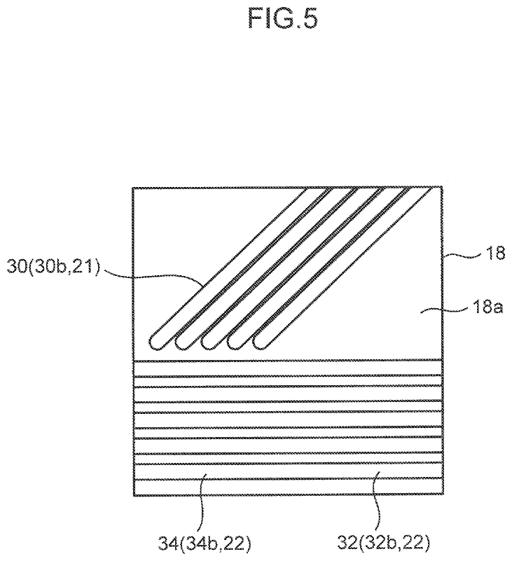

Specifically, each second board 18 (see FIG. 5) has the same rectangular shape as the first board 16 in a view in a direction along the thickness direction of the second board 18. Each second board 18 has a second board front surface 18a and a second board back surface. The second board front surface 18a is a surface that faces one side in a direction along the thickness direction of the second board 18 and that is in close contact with the first board back surface 16b (see FIGS. 6) of the first board 16 stacked on the second board 18. The second board back surface, on the other hand, is a surface facing the side opposite to the second board front surface 18a. Each second board front surface 18a (see FIG. 5) includes a plurality of second first-liquid introduction grooves 32b constituting the second first-liquid introduction channels 32, a plurality of second second-liquid introduction grooves 34b constituting the second second-liquid introduction channels 34, and a plurality of first channel confluence grooves 30b constituting the first confluence channels 30.

The second first-liquid introduction grooves 32b linearly extends from one side of the rectangular second board front surface 18a in a direction perpendicular to one side, and reaches a central part of the second board 18 in the direction. These second first-liquid introduction grooves 32b are arranged adjacent and parallel to each other in a row.

The second second-liquid introduction grooves 34b linearly extends from a side opposite to the one side of the second board front surface 18a in a direction perpendicular to the side, and reaches a central part of the second board 18 in the direction. These second second-liquid introduction grooves 34b are arranged adjacent and parallel to each other in a row. Each second second-liquid introduction groove 34b is disposed on an extension line of the corresponding second first-liquid introduction groove 32b, and extends in the same direction in which the second first-liquid introduction groove 32b extends. The second first-liquid introduction grooves 32b and the second second-liquid introduction grooves 34b are located in a half area of the second board front surface 18a in a direction perpendicular to the direction of extension of the second first-liquid introduction grooves 32b and second second-liquid introduction grooves 34b In a view in the stacking direction, the second first-liquid introduction grooves 32b and the second second-liquid introduction grooves 34b extend in a direction perpendicular to the direction of extension of the first first-liquid introduction grooves 24b and the first second-liquid introduction grooves 26b.

The first channel confluence grooves 30b are located in the other half area of the second board front surface 18a that is different from the half area in which the second first-liquid introduction grooves 32b and the second second-liquid introduction grooves 34b are arranged. The second board front surface 18a of the rectangular shape has two sides perpendicular to the other two sides of the second board front surface 18a, the other two sides being provided with one ends of the second first-liquid introduction grooves 32b and with one ends of the second second-liquid introduction grooves 34b, respectively. The first channel confluence grooves 30b extend diagonally from one of the other two sides that is in the area where the second first-liquid introduction grooves 32b and the second second-liquid introduction grooves 34b are not arranged, relative to the direction of extension of the second first-liquid introduction grooves 32b and the second second-liquid introduction grooves 34b These first channel confluence grooves 30b are arranged adjacent and parallel to each other in a row.

The second board front surface 18a of each second board 18 includes openings of the second first-liquid introduction grooves 32b, openings of the second second-liquid introduction grooves 34b, and openings of the first channel confluence grooves 30b, and these openings are sealed with the first board 16 in close contact with the second board front surface 18a. In the above manner, the second first-liquid introduction grooves 32b on each second board front surface 18a, the second first-liquid introduction grooves 32b having their openings sealed, form the second first-liquid introduction channels 32 arranged along the second board front surface 18a, and the second second-liquid introduction grooves 34b on each second board front surface 18a, the second second-liquid introduction grooves 34b having their openings sealed, form the second second-liquid introduction channels 34 arranged along the second board front surface 18a The first channel confluence grooves 30b on each second board front surface 18a, the first channel confluence grooves 30b having their openings sealed, form the first confluence channels 30 arranged on the second board front surface 18a. The second first-liquid introduction channels 32 and second second-liquid introduction channels 34 formed in the above manner are arranged in an area deviated from the first confluence channels 30, i.e., an area different from an area where the first confluence channels 30 are arranged in a view in the direction along the stacking direction.

The first confluence channels 30 arranged along each second board front surface 18a are configured such that respective flow rates per unit time of the liquid mixture in the first confluence channels 30 are equal. The first confluence channels 30 of all first channels 21 provided in the channel structure 2 are thus configured such that respective flow rates per unit time of the liquid mixture in the first confluence channels 30 are equal.

Each of the first confluence channels 30 arranged along each second board front surface 18a has a section perpendicular to the direction of flow of the liquid mixture in the first confluence channels 30. The shape of the section of each first confluence channel 30 is the same and therefore the area of the section of each first confluence channel 30 is the same. Thus, the section of each of the first confluence channels 30 of all first channels 21 provided in the channel structure 2, the section being perpendicular to the direction of flow of the liquid mixture, is the same in shape and in area as well. The channel length of each of the first confluence channels 30 arranged along each second board front surface 18a is also the same. Thus, the channel length of each of the first confluence channels 30 of all first channels 21 provided in the channel structure 2 is the same.

The channel structure 2 has four side surfaces each facing a direction perpendicular to the stacking direction of the first board 16 and the second board 18. The first first-liquid inlets 24a of the first channels 21, the first second-liquid inlets 26a of the first channels 21, the first outlets 30a of the first channels 21, the second first-liquid inlets 32a of the second channels 22, the second second-liquid inlets 34a of the second channels 22, and the second outlets 38a of the second channels 22 are arranged as groups of inlets or outlets in any given areas of the four side surfaces of the channel structure 2, respectively.

Specifically, the first first-liquid inlets 24a of the first channels 21 are provided on one side surface among the four side surfaces of the channel structure 2, and are arranged as a group of inlets in a half area of the one side surface, the half area being demarcated by dividing the one side surface at its center in the direction perpendicular to the stacking direction. The first second-liquid inlets 26a of the first channels 21 are provided on a different side surface among the four side surfaces of the channel structure 2, the different side surface being opposite to the side surface where the first first-liquid inlets 24a are provided, and are arranged as a group of inlets in a half area of the different side surface, the half area being demarcated by dividing the different side surface at its center in the direction perpendicular to the stacking direction and being on the same side on which the half area including the group of the first first-liquid inlets 24a is formed. The first outlets 30a of the first channels 21 are provided on the same side surface where the first first-liquid inlets 24a are provided, and are arranged as a group of outlets in the half area of the side surface that is opposite to of the half area where the first first-liquid inlets 24a are arranged as a group of inlets.

The second first-liquid inlets 32a of the second channels 22 are provided on one side surface that is one of remaining two side surfaces, among the four side surfaces of the channel structure 2, different from the side surface where the first first-liquid inlets 24a are provided and from the side surface where the first second-liquid inlets 26a are provided, and are arranged as a group of inlets in a half area of the one side surface, the half area being demarcated by dividing the one side surface at its center in the direction perpendicular to the stacking direction, such that the second first-liquid inlets 32a are on the side closer to the side where the first second-liquid inlets 26a are formed. The second second-liquid inlets 34a of the second channels 22 are provided on one side surface that is one of the remaining two side surfaces of the channel structure 2, the one side surface being opposite to the side surface where the second first-liquid inlets 32a are provided, and are arranged as a group of inlets in a half area of the one side surface, the half area being demarcated by dividing the different side surface at its center in the direction perpendicular to the stacking direction and being on the same side on which the half area including the group of the second first-liquid inlets 32a is formed. The second outlets 38a of the second channels 22 are provided on the same side surface where the second first-liquid inlets 32a are provided, and are arranged as a group of outlets in the half area of the side surface that is opposite to the half area where the second first-liquid inlets 32a are arranged as a group of inlets.

In the channel structure 2, therefore, the area where the first first-liquid inlets 24a are arranged as a group of inlets, the area where the first second-liquid inlets 26a are arranged as a group of inlets, the area where the first outlets 30a are arranged as a group of outlets, the area where the second first-liquid inlets 32a are arranged as a group of inlets, the area where the second second-liquid inlets 34a are arranged as a group of inlets, and the area where the second outlets 38a are arranged as a group of outlets are at different locations so that these areas do not overlap each other.

The first first-liquid distribution header 4 distributes the first liquid to the first first-liquid inlets 24a of all first channels 21 included in the channel structure 2. The first first-liquid distribution header 4 is attached to the side surface of the channel structure 2, the side surface having the first first-liquid inlets 24a formed thereon, so as to entirely cover the first first-liquid inlets 24a of all first channels 21 included in the channel structure 2. As a result, a space inside the first first-liquid distribution header 4 communicates with each first first-liquid inlets 24a. A first liquid supply pipe (not illustrated) for supplying the first liquid to the first first-liquid distribution header 4 is connected to the first first-liquid distribution header 4. The first liquid, which is supplied to the first first-liquid distribution header 4 through the first liquid supply pipe, is distributed from the space inside the first first-liquid distribution header 4 to each first first-liquid inlet 24a, and flows from the first first-liquid inlet 24a into each first first-liquid introduction channel 24.

The first second-liquid distribution header 6 distributes the second liquid to all first second-liquid inlets 26a of the first channels 21 included in the channel structure 2. The first second-liquid distribution header 6 is attached to the side surface of the channel structure 2, the side surface having the first second-liquid inlets 26a formed thereon, so as to entirely cover the first second-liquid inlets 26a of all first channels 21 included in the channel structure 2. As a result, a space inside the first second-liquid distribution header 6 communicates with each first second-liquid inlet 26a. A second liquid supply pipe (not illustrated) for supplying the second liquid to the first second-liquid distribution header 6 is connected to the first second-liquid distribution header 6. The second liquid, which is supplied to the first second-liquid distribution header 6 through the second liquid supply pipe, is distributed from the space inside the first second-liquid distribution header 6 to each first second-liquid inlet 26a, and flows from the first second-liquid inlet 26a into each first second-liquid introduction channel 26. On the channel structure 2, the side surface to which the first second-liquid distribution header 6 is attached is opposite to the side surface to which the first first-liquid distribution header 4 is attached.

The first recovery header 8 receives and recovers the liquid mixture of the first and second liquids that flows out of the first outlets 30a of all first channels 21 included in the channel structure 2. The first recovery header 8 is attached to the side surface of the channel structure 2, the side surface having the first outlets 30a formed thereon, so as to entirely cover the first outlets 30a of all first channels 21 included in the channel structure 2. As a result, a space inside the first recovery header 8 communicates with each first outlets 30a, and the liquid mixture, which flows through the first confluence channel 30 of each first channel 21, flows out from each first outlets 30a into the space inside the first recovery header 8. A first discharge pipe (not illustrated) is connected to the first recovery header 8. The liquid mixture, which has flown out from each first outlet 30a into the space inside the first recovery header 8 and been recovered there, is discharged through this first discharge pipe. On the channel structure 2, the side surface to which the first recovery header 8 is attached is the same side surface to which the first first-liquid distribution header 4 is attached. On this side surface, the first first-liquid distribution header 4 and the first recovery header 8 are juxtaposed such that they do not interfere with each other.

The second first-liquid distribution header 10 distributes the first liquid to the second first-liquid inlets 32a of all second channels 22 included in the channel structure 2. The second first-liquid distribution header 10 is attached to the side surface of the channel structure 2, the side surface having the second first-liquid inlets 32a formed thereon, so as to entirely cover the second first-liquid inlets 32a of all second channels 22 included in the channel structure 2 As a result, a space inside the second first-liquid distribution header 10 communicates with each second first-liquid inlets 32a. A first liquid supply pipe (not illustrated) for supplying the first liquid to the second first-liquid distribution header 10 is connected to the second first-liquid distribution header 10. The first liquid, which is supplied to the second first-liquid distribution header 10 through the first liquid supply pipe, is delivered from the space inside the second first-liquid distribution header 10 to each second first-liquid inlet 32a, and flows from the second first-liquid inlet 32a into each second first-liquid introduction channel 32. On the channel structure 2, the side surface to which the second first-liquid distribution header 10 is attached is a different side surface perpendicular to the side surface to which the first first-liquid distribution header 4 is attached and to the side surface to which the first second-liquid distribution header 6 is attached.

The second second-liquid distribution header 12 distributes the second liquid to the second second-liquid inlets 34a of all second channels 22 included in the channel structure 2. The second second-liquid distribution header 12 is attached to the side surface of the channel structure 2, the side surface having the second second-liquid inlets 34a formed thereon, so as to entirely cover the second second-liquid inlets 34a of all second channels 22 included in the channel structure 2. As a result, a space inside the second second-liquid distribution header 12 communicates with each second second-liquid inlet 34a. A second liquid supply pipe (not illustrated) for supplying the second liquid to the second second-liquid distribution header 12 is connected to the second second-liquid distribution header 12. The second liquid, which is supplied to the second second-liquid distribution header 12 through the second liquid supply pipe, is delivered from the space inside the second second-liquid distribution header 12 to each second second-liquid inlet 34a, and flows from the second second-liquid inlet 34a into each second second-liquid introduction channel 34. On the channel structure 2, the side surface to which the second second-liquid distribution header 12 is attached is a side surface opposite to the side surface to which the second first-liquid distribution header 10 is attached.

The second recovery header 14 receives and recovers the liquid mixture of the first and second liquids that flows out of the second outlets 38a of all second channels 22 included in the channel structure 2. The second recovery header 14 is attached to the side surface of the channel structure 2, the side surface having the second outlets 38a formed thereon, so as to entirely cover the second outlets 38a of all second channels 22 included in the channel structure 2. As a result, a space inside the second recovery header 14 communicates with each second outlet 38a, and the liquid mixture, which flows through the second confluence channel 38 of each second channel 22, flows out from each second outlet 38a into the space inside the second recovery header 14. A second discharge pipe (not illustrated) is connected to the second recovery header 14. The liquid mixture, which has flown out from each second outlet 38a into the space inside the second recovery header 14 and been recovered there, is discharged through this second discharge pipe. On the channel structure 2, the side surface to which the second recovery header 14 is attached is the same side surface to which the second first-liquid distribution header 10 is attached. On this side surface, the second first-liquid distribution header 10 and the second recovery header 14 are juxtaposed such that they do not interfere with each other.

In this embodiment, the second first-liquid introduction channels 32 and the second second-liquid introduction channels 34 are arranged along the second board front surface 18a such that they are located in an area deviated from the first confluence channels 30 in the area along the second board front surface 18a. As a result, in the area along the second board front surface 18a, a space where the first confluence channels 30 cannot be arranged, the space being created because of arrangement of the first confluence portions 28 on the first board 16 restricting arrangement of the first confluence channels 30 on the second board front surface 18a, is used effectively as a space where the second first-liquid introduction channels 32 and the second second-liquid introduction channels 34 are arranged. Therefore, even when the arrangement of the first confluence portions 28 restricts the arrangement of the first confluence channels 30 connected to the first confluence portions 28, unnecessary spaces where no channel is arranged are reduced in the channel structure 2 to increase a channel capacity per unit volume of the channel structure 2.

In this embodiment, the second confluence channels 38 are arranged along the first board front surface 16a such that they are located in an area deviated from the first first-liquid introduction channels 24 and the first second-liquid introduction channels 26 in the area along the first board front surface 16a. As a result, in the area along the first board front surface 16a, a space where the first first-liquid introduction channels 24 and the first second-liquid introduction channels 26 are not arranged is used effectively as a space where the second confluence channels 38 are arranged. This further reduces unnecessary spaces where no channel is arranged in the channel structure 2 to further increase the channel capacity per unit volume of the channel structure 2.

According to this embodiment, in the channel structure 2, the first first-liquid introduction channels 24, the first second-liquid introduction channels 26, and the second confluence channels 38 are arranged along the first board front surface 16a of the first board 16, and the second first-liquid introduction channels 32, the second second-liquid introduction channels 34, and the first confluence channels 30 are arranged along the second board front surface 18a of the second board 18. This configuration increases the channel capacity per unit volume of the channel structure 2.

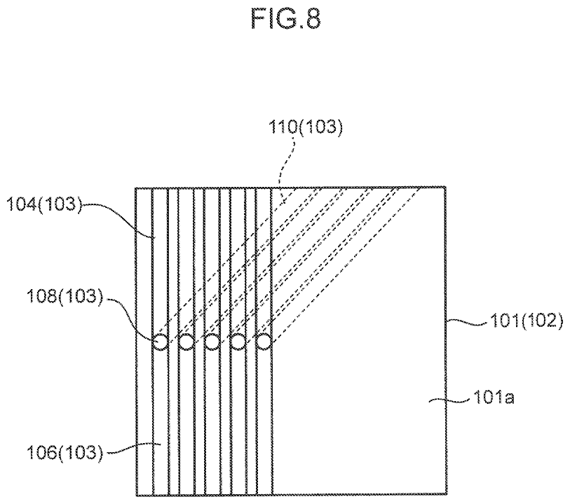

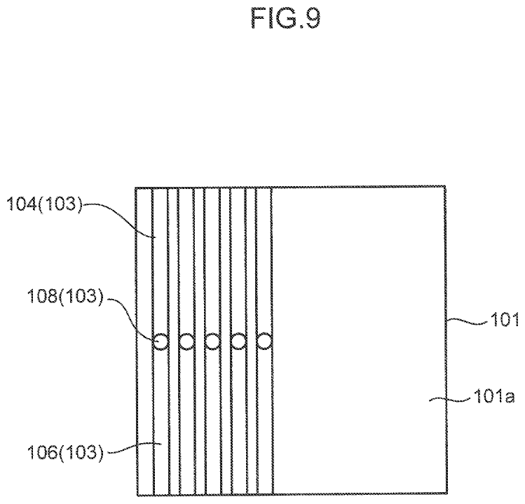

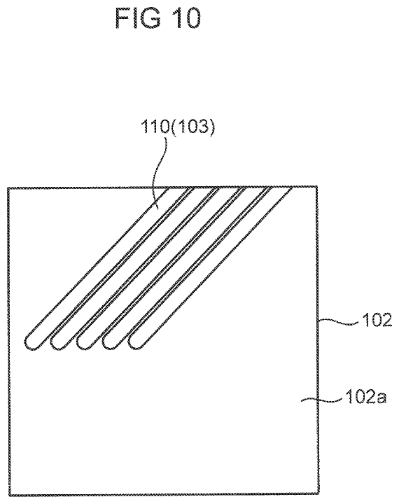

Specifically, for example, in comparative examples shown in FIGS. 8 to 10, only the first introduction channels 104 and the second introduction channels 106 of a plurality of channels 103 are arranged along a first board front surface 101a of a first board 101, only the confluence channels 110 of the plurality of channels 103 are arranged along a second board front surface 102a of a second board 102, and a plurality of confluence portions 108 connecting the first introduction channels 104, the second introduction channels 106, and the confluence channels 110 that correspond to each other are formed on the first board 101 so as to penetrate the first board 101 in its thickness direction. This configuration leaves many unnecessary areas on the first board 101 and the second board 102, the unnecessary areas being provided with no channel 103. Such a configuration shown in the comparative examples, therefore, reduces the channel capacity per unit volume of the channel structure.

In contrast, according to this embodiment, as described above, the second confluence channels 38 as well as the first first-liquid introduction channels 24 and the first second-liquid introduction channels 26 are arranged along the first board front surface 16a of each first board 16, and the first confluence channels 30 as well as the second first-liquid introduction channels 32 and the second second-liquid introduction channels 34 are arranged along the second board front surface 18a of each second board 18. This reduces unnecessary spaces on each first board 16 and each second board 18, the unnecessary spaces being provided with neither the first channels 21 nor the second channels 22. This configuration increases the channel capacity per unit volume of the channel structure 2.

According to this embodiment, the first first-liquid introduction grooves 24b, the first second-liquid introduction grooves 26b, and the second channel confluence grooves 38b are provided on the first board front surface 16a, and the second first-liquid introduction grooves 32b, the second second-liquid introduction grooves 34b, and the first channel confluence grooves 30b are provided on the second board front surface 18a. If the first first-liquid introduction grooves, the first second-liquid introduction grooves, and the second channel confluence grooves are provided on the first board front surface and on the second board back surface as well and the second first-liquid introduction grooves, the second second-liquid introduction grooves, and the first channel confluence grooves are provided on the first board back surface and on the second board front surface as well, when the first board and the second board are stacked together to form the channel structure, the first first-liquid introduction grooves, the first second-liquid introduction grooves, and the second channel confluence grooves, the grooves being provided on both surfaces, need to be matched to each other, and the second first-liquid introduction grooves, the second second-liquid introduction grooves, and the first channel confluence grooves, the grooves being provided on both surfaces, need to be also matched to each other. According to this embodiment, however, such an operation of matching grooves formed respectively on both surfaces is unnecessary, and therefore an operation of forming the channel structure 2 is simplified.

According to this embodiment, as described above, the channel device 1 includes the first first-liquid distribution header 4, the first second-liquid distribution header 6, the first recovery header 8, the second first-liquid distribution header 10, the second second-liquid distribution header 12, and the second recovery header 14 that are attached to the channel structure 2. Because of these headers, compared with a case where first liquid supply units for supplying the first liquid are connected respectively to the first first-liquid inlets 24a of all first channels 21 provided in the channel structure 2 and second liquid supply units for supplying the second liquid are connected respectively to the first second-liquid inlets 26a of all first channels 21, the first liquid is distributed and supplied to the first first-liquid inlets 24a as the second liquid is distributed and supplied to the first second-liquid inlets 26a in a simpler configuration. Likewise, compared with a case where first liquid supply units for supplying the first liquid are connected respectively to the second first-liquid inlets 32a of all second channels 22 provided in the channel structure 2 and second liquid supply units for supplying the second liquid are connected respectively to the second second-liquid inlets 34a of all second channels 22, the first liquid is distributed and supplied to the second first-liquid inlets 32a as the second liquid is distributed and supplied to the second second-liquid inlets 34a in a simpler configuration. Compared with a case where recover units for recovering the liquid mixture are connected respectively to the first outlets 30a of all first channels 21 provided in the channel structure 2, the liquid mixture flowing out of the first outlets 30a is recovered in a simpler configuration. Likewise, compared with a case where recover units for recovering the liquid mixture are connected respectively to the second outlets 38a of all second channels 22 provided in the channel structure 2, the liquid mixture flowing out of the second outlets 38a is recovered in a simpler configuration.

According to this embodiment, the first confluence channels 30 arranged parallel to each other along the second board front surface 18a of each second board 18 are configured such that respective flow rates per unit time of the liquid mixture in the first confluence channels 30 are equal, and the second confluence channels 38 arranged parallel to each other along the first board front surface 16a of each first board 16 are configured such that respective flow rates per unit time of the liquid mixture in the second confluence channels 38 are equal. This prevents a case where a difference in a processing time for interaction between the first liquid and the second liquid arises in the first confluence channels 30 arranged parallel to each other along the second board front surface 18a of each second board 18, and prevents also a case where a difference in a processing time for interaction between the first liquid and the second liquid arises in the second confluence channels 38 arranged parallel to each other along the first board front surface 16a of each first board 16.

### Modifications

The channel device according to the present invention is not necessarily limited to the channel device according to the above embodiment. For example, the following techniques may be applied to the channel device according to the present invention.

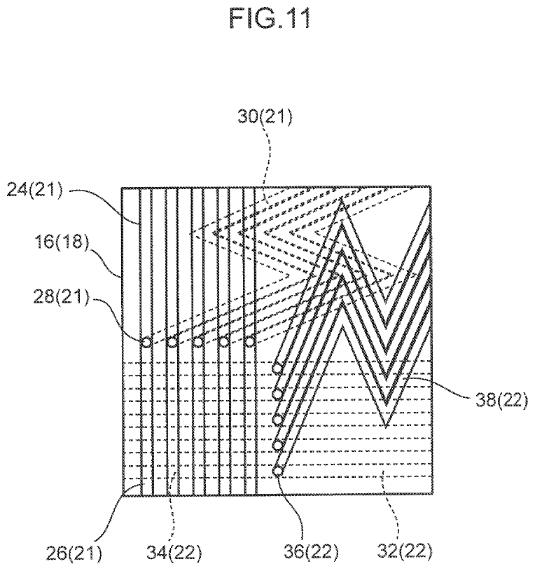

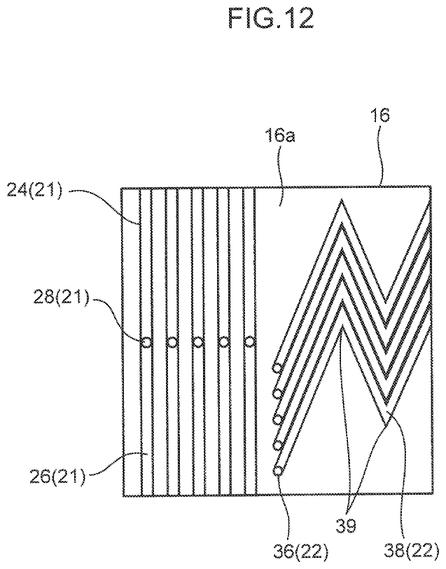

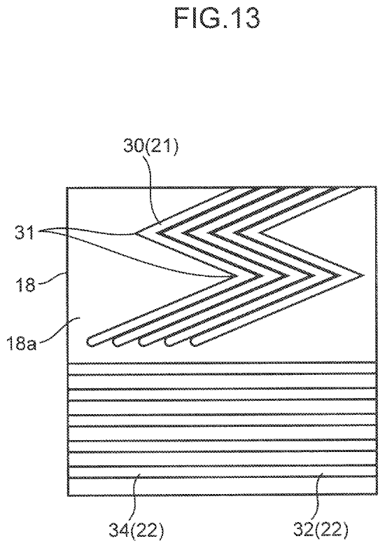

(1) The first confluence channel of each first channel may have at least one first bent part, which is bent so as to change the direction of flow of the liquid mixture in the first confluence channel, and the second confluence channel of each second channel may have at least one second bent part, which is bent so as to change the direction of flow of the liquid mixture in the second confluence channel. FIGS. 11 to 13 show arrangement of the first channels and the second channels in the channel device, according to a first modification of the present invention to which the above technique is applied.

The channel device 1 according to this first modification has the same configuration as the configuration of the channel device 1 according to the embodiment, except the configuration of the first confluence channel 30 of each first channel 21 and the second confluence channel 38 of each second channel 22. In the first modification, the first confluence channel 30 of each first channel 21 has two first bent parts 31 and the second confluence channel 38 of each second channel 22 has two second bent parts 39.

The first confluence channel 30 has a bent shape so that the direction of flow of the liquid mixture of the first and second liquids flowing through the first confluence channel 30 changes at each of the first bent parts 31. Likewise, the second confluence channel 38 has a bent shape so that the direction of flow of the liquid mixture of the first and second liquids flowing through the second confluence channel 38 changes at each of the second bent parts 39. In the first modification, the number of the first bent parts 31 of each of the first confluence channels 30 arranged along the second board front surface 18a of each second board 18 is the same, and the number of the second bent parts 39 of each of the second confluence channels 38 arranged along the first board front surface 16a of each first board 16 is the same. The first confluence channel 30 of each first channel 21 meanders because the first confluence channel 30 has two first bent parts 31, and the second confluence channel 38 of each second channel 22 meanders because the second confluence channel 30 has two second bent parts 39.

According to the first modification, because each first confluence channel 30 has two first bent parts 31, the channel length of each first confluence channel 30 is made longer than the length in a case where each first confluence channel 30 extends linearly as a whole. Likewise, because each second confluence channel 38 has two second bent parts 39, the channel length of each second confluence channel 38 is made longer than the length in a case where each second confluence channel 38 extends linearly as a whole. As a result, a time for the liquid mixture to flow in each first confluence channel 30 and each second confluence channel 38 is made longer, and therefore the processing time for interaction between the first and second liquids in each first confluence channel 30 and each second confluence channel 38 is made longer.

In the first modification, the number of the first bent parts 31 of each of the first confluence channels 30 being the same prevents a case where a difference in the flow rate per unit time of the liquid mixture arises between the first confluence channels 30 because of the presence of the first bent parts 31. Likewise, the number of the second bent parts 39 in each of the second confluence channels 38 being the same prevents a case where a difference in the flow rate per unit time of the liquid mixture arises between the second confluence channels 38 because of the presence of the second bent parts 39.

The number of the first bent parts 31 of each first confluence channel 30 and the number of the second bent parts 39 of each second confluence channel 38 may be determined to be any given number.

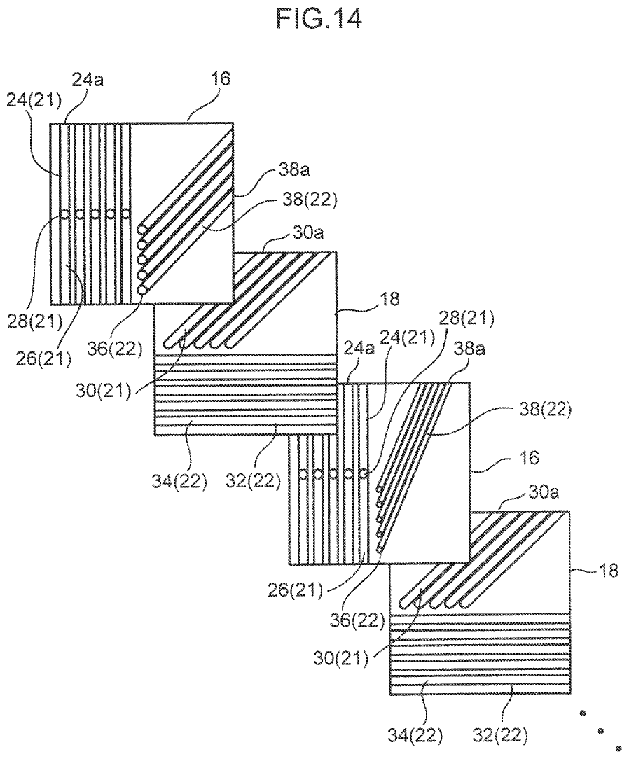

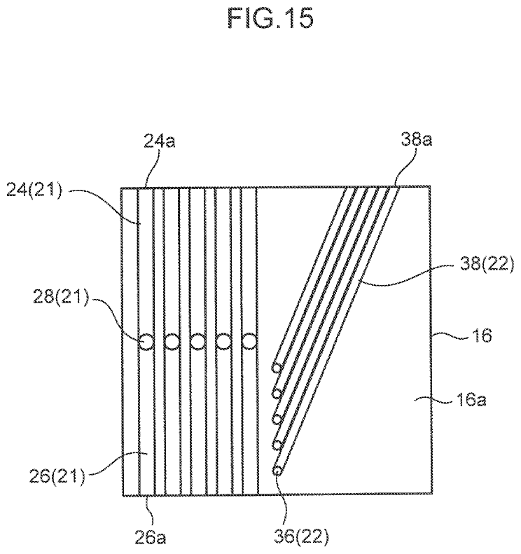

(2) Respective arrangement patterns of the first first-liquid introduction channels, the first second-liquid introduction channels, and the second confluence channels, which are arranged along the first board front surface, may be the same for every stack of two or more first boards in the stacking direction. FIGS. 14 and 15 show channel arrangement patterns in the channel device according to a second modification of the present invention to which the above technique is applied.

According to the second modification, in the first boards 16 constituting the channel structure, the first board 16 having the first first-liquid introduction channels 24, the first second-liquid introduction channels 26, and the second confluence channels 38 arranged in the same pattern along the first board front surface 16a appears for every stack of two first boards 16 in the stacking direction.

Specifically, in the first boards 16 stacked in the stacking direction, the first board 16 having the first first-liquid introduction channels 24, the first second-liquid introduction channels 26, and the second confluence channels 38 arranged in the same pattern appears as the first first board 16, and although not illustrated, as other first boards 16 for every stack of two first boards 16 (the third first board 16, the fifth first board 16, and so on).

Likewise, in the first boards 16 stacked in the stacking direction, the first board 16 having the first first-liquid introduction channels 24, the first second-liquid introduction channels 26, and the second confluence channels 38 arranged in the same pattern appears as the second first board 16, and although not illustrated, as other first boards 16 for every stack of two first boards 16 (the fourth first board 16, the sixth first board 16, and so on). The same arrangement pattern of the first first-liquid introduction channels 24, the first second-liquid introduction channels 26, and the second confluence channels 38 in this case, however, is different from the same arrangement pattern in the case where the same arrangement pattern appears at the first first board 16 and at other first boards 16 for every stack of two first boards 16. Specifically, according to the arrangement pattern of this case, the second confluence channels 38 extend diagonally from the second confluence portions 36, at an angle steeper than an angle at which the second confluence channels 38 extend in the case of the same arrangement pattern appearing at the first first board 16 and at other first boards 16 for every stack of two first boards 16, and reaches the side of the first board 16 that is provided with the first first-liquid inlets 24a, and the second outlets 38a are provided on this side.

In the second modification, because the same arrangement pattern of the first first-liquid introduction channels 24, the first second-liquid introduction channels 26, and the second confluence channels 38 can be applied to the first boards 16 for every specific number of the first boards 16, the productivity of the channel structure 2 is improved to be higher than the productivity in the case where the arrangement pattern of the first first-liquid introduction channels 24, the first second-liquid introduction channels 26, and the second confluence channels 38 differs at each first board 16.

In the second modification, the second outlets 38a of the second confluence channels 38 that are lined up on the second first board 16 and on other first boards 16 for every stack of two first boards 16 among the first boards 16 stacked in the stacking direction are arranged as a group of outlets in an area that overlaps an area where the first outlets 30a of the first channels 21 are arranged as a group of outlets in a view in the direction along the stacking direction. Because of this configuration, the first recovery header 8 may cover the second outlets 38a of the second confluence channels 38, the second outlets 38a being lined up on the second first board 16 and on other first boards 16 for every stack of two first boards 16, as well as the first outlets 30a of the first channels 21, and the first recovery header 8 may recover the liquid mixture flowing out of the second outlets 38a as well as the liquid mixture flowing out of the first outlets 30a.

The above concept of the arrangement pattern of the first first-liquid introduction channels, the first second-liquid introduction channels, and the second confluence channels, which are arranged along the first board front surface, may be applied to the second first-liquid introduction channels, the second second-liquid introduction channels, and the first confluence channels, which are arranged along the second board front surface, to make their arrangement pattern the same for every stack of two or more second boards in the stacking direction. In such a case, a plurality of different arrangement patterns may be adopted as arrangement patterns of the second first-liquid introduction channels, the second second-liquid introduction channels, and the first confluence channels.

(3) The second confluence channels of the second channels does not necessarily need to be arranged on the first board front surface of the first board in close contact with the second board front surface where the second first-liquid introduction channels and the second second-liquid introduction channels of the second channels are arranged, and may be arranged along the first board front surface of the first board in close contact with the second board back surface opposite to the second board front surface where the second first-liquid introduction channels and the second second-liquid introduction channels of the second channels are arranged.

(4) The first first-liquid introduction grooves constituting the first first-liquid introduction channels may be formed on the second board back surface and may be formed on the first board front surface and on the second board back surface as well. When the first first-liquid introduction grooves are formed on the first board front surface and on the second board back surface as well, both first first-liquid introduction grooves formed respectively on the first board front surface and the second board back surface are matched by bringing the first board front surface and the second board back surface into close contact with each other and the matched first first-liquid introduction grooves constitute the first first-liquid introduction channels.

(5) The first second-liquid introduction grooves constituting the first second-liquid introduction channels may be formed on the second board back surface and may be formed on the first board front surface and on the second board back surface as well. When the first second-liquid introduction grooves are formed on the first board front surface and on the second board back surface as well, both first second-liquid introduction grooves formed respectively on the first board front surface and the second board back surface are matched by bringing the first board front surface and the second board back surface into close contact with each other and the matched first second-liquid introduction grooves constitute the first second-liquid introduction channels.

(6) The first channel confluence grooves constituting the first confluence channels may be formed on the first board back surface and may be formed on the first board back surface and on the second board front surface as well. When the first channel confluence grooves are formed on the first board back surface and on the second board front surface as well, both first channel confluence grooves formed respectively on the first board back surface and the second board front surface are matched by bringing the first board back surface and the second board front surface into close contact with each other and the matched first channel confluence grooves constitute first confluence channels.

(7) The second first-liquid introduction grooves constituting the second first-liquid introduction channels may be formed on the first board back surface and may be formed on the first board back surface and on the second board front surface as well. When the second first-liquid introduction grooves are foinied on the first board back surface and on the second board front surface as well, both second first-liquid introduction grooves formed respectively on the first board back surface and the second board front surface are matched by bringing the first board back surface and the second board front surface into close contact with each other and the matched second first-liquid introduction grooves constitute the second first-liquid introduction channels.

(8) The second second-liquid introduction grooves constituting the second second-liquid introduction channels may be formed on the first board back surface and may be formed on the first board back surface and on the second board front surface as well. When the second second-liquid introduction grooves are formed on the first board back surface and on the second board front surface as well, both second second-liquid introduction grooves formed respectively on the first board back surface and the second board front surface are matched by bringing the first board back surface and the second board front surface into close contact with each other and the matched second second-liquid introduction grooves constitute the second second-liquid introduction channels.

(9) According to the present invention, respective areas of first boards where the first first-liquid inlets are arranged as a group of inlets may be shifted to each other in a view in the direction along the stacking direction. Respective areas of first boards where the first second-liquid inlets are arranged as a group of inlets may be shifted to each other in a view in the direction along the stacking direction. Respective areas of first boards where the second outlets are arranged as a group of outlets may be shifted to each other in a view in the direction along the stacking direction.

(10) According to the present invention, respective areas of second boards where the second first-liquid inlets are arranged as a group of inlets may be shifted to each other in a view in the direction along the stacking direction. Respective areas of second boards where the second second-liquid inlets are arranged as a group of inlets may be shifted to each other in a view in the direction along the stacking direction. Respective areas of second boards where the first outlets are arranged as a group of outlets may be shifted to each other in a view in the direction along the stacking direction.

(11) According to the present invention, each first board may be formed of two divided pieces of boards that are stacked together in the thickness direction of the first board. In this case, one board of the two pieces of boards, the one board constituting the first board front surface, may include a plurality of first first-liquid introduction slits for forming the first first-liquid introduction grooves, a plurality of first second-liquid introduction slits for forming the first second-liquid introduction grooves, and a plurality of second channel confluence slits for forming the second channel confluence grooves, the slits being formed so as to penetrate the one board in its thickness direction, and the other board of the two pieces of boards, the other board constituting the first board back surface, may include a plurality of through-holes for forming the first confluence portion through-holes at the positions corresponding to the positions of the first confluence portions, the through-holes being formed so as to penetrate the other board in its thickness direction, and a plurality of through-holes for forming the second confluence portion through-holes at the positions corresponding to the positions of the second confluence portions, the through-holes being formed so as to penetrate the other board in its thickness direction.

In this configuration, back-side openings of the first first-liquid introduction slits formed on the one board are sealed with the other board to form the first first-liquid introduction grooves, back-side openings of the first second-liquid introduction slits formed on the one board are sealed with the other board to fouii the first second-liquid introduction grooves, and back-side openings of the second channel confluence slits formed on the one board are sealed with the other board to form the second channel confluence grooves. The through-holes for forming the first confluence portion through-holes, the through-holes being provided on the other board, are connected respectively to ends of the first first-liquid introduction slits corresponding to the through-holes and to ends of the first second-liquid introduction slits corresponding to the through-holes, both slits being provided on the one board, to form the first confluence portion through-holes. Likewise, the through-holes for forming the second confluence portion through-holes, the through-holes being provided on the other board, are connected respectively to ends of the second channel confluence slits corresponding to the through-holes, the slits being provided on the one board, to form the first confluence portion through-holes.

(12) According to the present invention, each second board may be formed of two divided pieces of boards that are stacked together in the thickness direction of the second board. In this case, one board of the two pieces of boards, the one board constituting the second board front surface, may include a plurality of second first-liquid introduction slits for forming the second first-liquid introduction grooves, a plurality of second second-liquid introduction slits for forming the second second-liquid introduction grooves, and a plurality of first channel confluence slits for forming the first channel confluence grooves, the slits being formed so as to penetrate the one board in its thickness direction.

In this configuration, back-side openings of the second first-liquid introduction slits formed on the one board are sealed with the other board of the two pieces of boards, the other board constituting the second board back surface, to form the second first-liquid introduction grooves, back-side openings of the second second-liquid introduction slits formed on the one board are sealed with the other board to form the second second-liquid introduction grooves, and back-side openings of the first channel confluence slits formed on the one board are sealed with the other board to form the first channel confluence grooves.

### Summary of Embodiments and Modifications

The embodiment and the modifications are summarized as follows.

A channel device according to the embodiment and modifications includes a plurality of first channels and a plurality of second channels that allow a first liquid and a second liquid to join and flow through the first and second channels, respectively. The channel device includes a channel structure having therein the plurality of the first channels and the plurality of the second channels. Each of the plurality of the first channels includes: a first first-liquid introduction channel into which the first liquid is introduced; a first second-liquid introduction channel into which the second liquid is introduced; a first confluence portion connected to both a downstream end of the first first-liquid introduction channel and a downstream end of the first second-liquid introduction channel to cause the first liquid flowing through the first first-liquid introduction channel and the second liquid flowing through the first second-liquid introduction channel to join together; and a first confluence channel connected to the first confluence portion on a downstream side of the first confluence portion to allow a liquid mixture of the first liquid and the second liquid having joined at the first confluence portion to flow through the first confluence channel. Each of the plurality of the second channels includes: a second first-liquid introduction channel into which the first liquid is introduced; a second second-liquid introduction channel into which the second liquid is introduced; a second confluence portion connected to both a downstream end of the second first-liquid introduction channel and a downstream end of the second second-liquid introduction channel to cause the first liquid flowing through the second first-liquid introduction channel and the second liquid flowing through the second second-liquid introduction channel to join together; and a second confluence channel connected to the second confluence portion on a downstream side of the second confluence portion to allow a liquid mixture of the first liquid and the second liquid having joined at the second confluence portion to flow through the second confluence channel. The channel structure includes a plurality of first boards and a plurality of second boards, and the first board and the second board are stacked alternately along a thickness direction of each of the first board and the second board. Each of the plurality of the first boards has a first board front surface and a first board back surface, and the first board front surface is one surface of the first board in the thickness direction of the first board while the first board back surface is the other surface opposite to the first board front surface. Each of the plurality of the second boards has a second board front surface and a second board back surface, and the second board front surface is one surface of the second board in the thickness direction of the second board, the one surface being in close contact with the first board back surface of the first board stacked on the second board, while the second board back surface is the other surface opposite to the second board front surface, the other surface being in close contact with the first board front surface of the first board on which the second board is stacked. The first first-liquid introduction channels of the plurality of the first channels include a plurality of the first first-liquid introduction channels arranged along the first board front surface of each of the plurality of the first boards. The first second-liquid introduction channels of the plurality of the first channels include a plurality of the first second-liquid introduction channels arranged along the first board front surface of each of the plurality of the first boards. The first confluence channels of the plurality of the first channels include a plurality of the first confluence channels arranged along the second board front surface of each of the plurality of the second boards. The first confluence portions of the plurality of the first channels in each of the first boards are configured of a plurality of first confluence portion through-holes that penetrate the first board in the thickness direction of the first board. The second first-liquid introduction channels of the plurality of the second channels and the second second-liquid introduction channels of the plurality of the second channels are arranged along the respective second board front surfaces of the plurality of the second boards, and are located in an area that is deviated from the plurality of the first confluence channels in a view in a direction along a stacking direction of the first board and the second board.

In this channel device, because the second first-liquid introduction channels and the second second-liquid introduction channels that are arranged along the second board front surface are located in an area that is deviated from the first confluence channels in the area along the second board front surface, a space where the first confluence channels cannot be arranged in the area along the second board front surface, the space being created because of arrangement of the first confluence portions on the first board restricting arrangement of the first confluence channels on the second board front surface, is used effectively as a space where the second first-liquid introduction channels and the second second-liquid introduction channels are arranged. Therefore, even when the arrangement of the first confluence portions restricts the arrangement of the first confluence channels connected to the first confluence portions, unnecessary spaces where no channel is arranged are reduced in the channel structure to increase a channel capacity per unit volume of the channel structure.

It is preferable that the second confluence portions of the plurality of the second channels in each of the first boards are configured of a plurality of second confluence portion through-holes that penetrate the first board in the thickness direction of the first board, that the second confluence channels of the plurality of the second channels include a plurality of the second confluence channels arranged along the first board front surface of each of the plurality of the first boards, and that the plurality of the second confluence channels arranged along the first board front surface are located in an area that is deviated from the plurality of the first first-liquid introduction channels and the plurality of the first second-liquid introduction channels in a view in a direction along the stacking direction.

In this configuration, because the second confluence channels arranged along the first board front surface are located in an area that is deviated from the first first-liquid introduction channels and the first second-liquid introduction channels in the area along the first board front surface, a space where neither the first first-liquid introduction channels nor the first second-liquid introduction channels are arranged in the area along the first board front surface is used effectively as a space where the second confluence channels are arranged. This further reduces unnecessary spaces where no channel is arranged in the channel structure, thus further increasing the channel capacity per unit volume of the channel structure.

It is preferable that the first first-liquid introduction channels arranged along the first board front surface of each of the plurality of the first boards are configured of a plurality of first first-liquid introduction grooves formed on at least one of the first board front surface and the second board back surface in close contact with the first board front surface, that the plurality of the first second-liquid introduction channels arranged along the first board front surface of each of the plurality of the first boards are configured of a plurality of first second-liquid introduction grooves formed on at least one of the first board front surface and the second board back surface in close contact with the first board front surface, that the plurality of the first confluence channels arranged along the second board front surface of each of the plurality of the second boards are configured of a plurality of first confluence grooves formed on at least one of the second board front surface and the first board back surface in close contact with the second board front surface, that the plurality of the second first-liquid introduction channels arranged along the second board front surface of each of the plurality of the second boards are configured of a plurality of second first-liquid introduction grooves formed on at least one of the second board front surface and the first board back surface in close contact with the second board front surface, that the plurality of the second second-liquid introduction channels arranged along the second board front surface of each of the plurality of the second boards are configured of a plurality of second second-liquid introduction grooves formed on at least one of the second board front surface and the first board back surface in close contact with the second board front surface, and that the plurality of the second confluence channels arranged along the first board front surface of each of the plurality of the first boards are configured of a plurality of second confluence grooves formed on at least one of the first board front surface and the second board back surface in close contact with the first board front surface.

According to this configuration, by a simple operation of alternately stacking each first board having a plurality of grooves formed on the first board front surface and/or the first board back surface and each second board having a plurality of grooves formed on the second board front surface and/or the second board back surface to bring the second board front surface into close contact with the first board back surface of each first board and bring the first board front surface into close contact with the second board back surface of each second board, the first first-liquid introduction channels, the first second-liquid introduction channels, the first confluence channels, the second first-liquid introduction channels, the second second-liquid introduction channels, and the second confluence channels can be formed in the channel structure.

It is preferable that the first first-liquid introduction groove constituting the first first-liquid introduction channel is provided on only one of the first board front surface and the second board back surface in close contact with the first board front surface, that the first second-liquid introduction groove constituting the first second-liquid introduction channel is provided on only one of the first board front surface and the second board back surface in close contact with the first board front surface, that the first confluence groove constituting the first confluence channel is provided on only one of the second board front surface and the first board back surface in close contact with the second board front surface, that the second first-liquid introduction groove constituting the second first-liquid introduction channel is provided on only one of the second board front surface and the first board back surface in close contact with the second board front surface, that the second second-liquid introduction groove constituting the second second-liquid introduction channel is provided on only one of the second board front surface and the first board back surface in close contact with the second board front surface, and that the second confluence groove constituting the second confluence channel is provided on only one of the first board front surface and the second board back surface in close contact with the first board front surface.

In a case where the first first-liquid introduction groove, the first second-liquid introduction groove, and the second confluence groove are provided on the first board front surface and on the second board back surface as well while the second first-liquid introduction groove, the second second-liquid introduction groove, and the first confluence groove are provided on the first board back surface and on the second board front surface as well, forming the channel structure by stacking the first board and the second board together requires that the first first-liquid introduction groove, the first second-liquid introduction groove, and the second confluence groove, the grooves being provided on both surfaces, be matched to each other and that the second first-liquid introduction groove, the second second-liquid introduction groove, and the first confluence groove, the grooves being provided on both surfaces, be also matched to each other. According to the above configuration, however, such matching of the grooves is unnecessary. This simplifies work of constructing the channel structure.

It is preferable that the plurality of the first boards include a plurality of selected first boards that are selected out of the plurality of the first boards, that the first first-liquid introduction channels, the first second-liquid introduction channels, and the second confluence channels are arranged along the respective first board front surfaces of the plurality of the selected first boards in respective arrangement patterns, the respective arrangement patterns being equal to each other, and that the plurality of the selected first boards include at least one pair of adjacent first boards which are constituted by two of the selected first boards adjacent to each other in the stacking direction, and a specific number of boards are interposed between each of the at least one pair of the adjacent first boards, the specific number of boards being selected from the plurality of the first boards and the plurality of the second boards except for the selected first boards.

According to this configuration, because the same arrangement pattern is applied to the first first-liquid introduction channels, the first second-liquid introduction channels, and the second confluence channels that are arranged respectively along the first board front surfaces of the selected first boards, the productivity of production of the channel structure is improved to be higher than the productivity in a case where respective arrangement patterns of the first first-liquid introduction channels, the first second-liquid introduction channels, and the second confluence channels that are arranged respectively along the first board front surfaces of the first boards are different from each other.

It is preferable that the first first-liquid introduction channels, the first second-liquid introduction channels, and the second confluence channels are arranged along the respective first board front surfaces of the plurality of the first boards in respective arrangement patterns, and all of the respective arrangement patterns are same.

According to this configuration, the productivity of production of the channel structure is further improved.

It is preferable that the plurality of the second boards include a plurality of selected second boards that are selected out of the plurality of the second boards, that the second first-liquid introduction channels, the second second-liquid introduction channels, and the first confluence channels are arranged along the respective second board front surfaces of the plurality of the selected second boards in respective arrangement patterns, the respective arrangement patterns being equal to each other, and that the plurality of the selected second boards include at least one pair of adjacent second boards which are constituted by two of the selected second boards adjacent to each other in the stacking direction, and a specific number of boards are interposed between each of the at least one pair of the adjacent second boards, the specific number of boards being selected from the plurality of the first boards and the plurality of the second boards except for the selected second boards.

According to this configuration, because the same arrangement pattern is applied to the second first-liquid introduction channels, the second second-liquid introduction channels, and the first confluence channels that are arranged respectively along the second board front surfaces of the selected second boards, the productivity of production of the channel structure is improved to be higher than the productivity in a case where respective arrangement patterns of the second first-liquid introduction channels, the second second-liquid introduction channels, and the first confluence channels that are arranged respectively along the second board front surfaces of the second boards are different from each other.

It is preferable that the second first-liquid introduction channels, the second second-liquid introduction channels, and the first confluence channels are arranged along the respective second board front surfaces of the plurality of the second boards in respective arrangement patterns, and all of the respective arrangement patterns are same.

According to this configuration, the productivity of production of the channel structure is further improved.

The first first-liquid introduction channel may have a first first-liquid inlet that allows the first liquid to flow into the first first-liquid introduction channel through the first first-liquid inlet, the first second-liquid introduction channel may have a first second-liquid inlet that allows the second liquid to flow into the first second-liquid introduction channel through the first second-liquid inlet, the second first-liquid introduction channel may have a second first-liquid inlet that allows the first liquid to flow into the second first-liquid introduction channel through the second first-liquid inlet, the second second-liquid introduction channel may have a second second-liquid inlet that allows the second liquid to flow into the second second-liquid introduction channel through the second second-liquid inlet, the first first-liquid inlets of the plurality of the first channels may be collectively arranged in a partial area of any given side surface selected from a plurality of side surfaces of the channel structure, the first second-liquid inlets of the plurality of the first channels may be collectively arranged in a partial area of any given side surface selected from the plurality of the side surfaces, the second first-liquid inlets of the plurality of the second channels may be collectively arranged in a partial area of any given side surface selected from the plurality of the side surfaces, and the second second-liquid inlets of the plurality of the second channels may be collectively arranged in a partial area of any given side surface selected from the plurality of the side surfaces.

According to this configuration, device connection for distributing the first liquid to the first first-liquid inlets is made easier than a case where the first first-liquid inlets are arranged as inlets separated apart from each other, and device connection for distributing the second liquid to the first second-liquid inlets is made easier than a case where the first second-liquid inlets are arranged as inlets separated apart from each other. Likewise, device connection for distributing the first liquid to the second first-liquid inlets is made easier than a case where the second first-liquid inlets are arranged as inlets separated apart from each other, and device connection for distributing the second liquid to the second second-liquid inlets is made easier than a case where the second second-liquid inlets are arranged as inlets separated apart from each other.

It is preferable that the channel device further includes: a first first-liquid distribution header attached to the channel structure so as to entirely cover the first first-liquid inlets of the plurality of the first channels to distribute the first liquid to the first first-liquid inlets of the plurality of the first channels; a first second-liquid distribution header attached to the channel structure so as to entirely cover the first second-liquid inlets of the plurality of the first channels to distribute the second liquid to the first second-liquid inlets of the plurality of the first channels; a second first-liquid distribution header attached to the channel structure so as to entirely cover the second first-liquid inlets of the plurality of the second channels to distribute the first liquid to the second first-liquid inlets of the plurality of the second channels; and a second second-liquid distribution header attached to the channel structure so as to entirely cover the second second-liquid inlets of the plurality of the second channels to distribute the second liquid to the second second-liquid inlets of the plurality of the second channels.

According to this configuration, compared with a case where first liquid supply units for supplying the first liquid are separately connected to the first first-liquid inlets, respectively, and second liquid supply units for supplying the second liquid are separately connected to the first second-liquid inlets, respectively, the first liquid is distributed and supplied to each of the first first-liquid inlets as the second liquid is distributed and supplied to each of the first second-liquid inlets in a simpler configuration. Likewise, compared with a case where first liquid supply units for supplying the first liquid are separately connected to the second first-liquid inlets, respectively, and second liquid supply units for supplying the second liquid are separately connected to the second second-liquid inlets, respectively, the first liquid is distributed and supplied to each of the second first-liquid inlets as the second liquid is distributed and supplied to each of the second second-liquid inlets in a simpler configuration.

It is preferable that the first confluence channel has a first outlet that causes the liquid mixture to flow out, the liquid mixture flowing through the first confluence channel, that the second confluence channel has a second outlet that causes the liquid mixture to flow out, the liquid mixture flowing through the second confluence channel, that the first outlets of the plurality of the first channels are collectively arranged in a partial area of any given side surface selected from a plurality of side surfaces of the channel structure, and that the second outlets of the plurality of the second channels are collectively arranged in a partial area of any given side surface selected from the plurality of the side surfaces.

It is preferable that the channel device further includes: a first recovery header attached to the channel structure so as to entirely cover the first outlets of the plurality of the first channels to receive and recover the liquid mixture flowing out of the first outlets; and a second recovery header attached to the channel structure so as to entirely cover the second outlets of the plurality of the second channels to receive and recover the liquid mixture flowing out of the second outlets.

According to this configuration, compared with a case where recover units for recovering the liquid mixture are separately connected to the first outlets, the liquid mixture flowing out of the first outlets is recovered in a simpler configuration, and, compared with a case where recover units for recovering the liquid mixture are separately connected to the second outlets, the liquid mixture flowing out of the second outlets is recovered in a simpler configuration.

It is preferable that the first confluence channels of the plurality of the first channels are configured such that respective flow rates per unit time of the liquid mixture in the first confluence channels are equal, and that the second confluence channels of the plurality of the first channels are configured such that respective flow rates per unit time of the liquid mixture in the second confluence channels are equal.

According to this configuration, conditions under which the liquid mixture flows through respective first confluence channels are brought closer to the same condition, and conditions under which the liquid mixture flows through respective second confluence channels are brought closer to the same condition.

It is preferable that the first confluence channel of each of the plurality of the first channels has a first cross section that is a cross section perpendicular to a flow direction of the liquid mixture in each first confluence channel, and the respective first cross sections of the first confluence channels have the same area, and that the second confluence channel of each of the plurality of the second channels has a second cross section that is a cross section perpendicular to a flow direction of the liquid mixture in each second confluence channel, and the respective second cross sections of the second confluence channels have the same area.

This configuration prevents a case where a difference in the flow rate per unit time of the liquid mixture arises between the first confluence channels because of a difference in the area of the first cross section and prevents also a case where a difference in the flow rate per unit time of the liquid mixture arises between the second confluence channels because of a difference in the area of the second cross section.

It is preferable that the respective first cross sections of the first confluence channels of the plurality of the first channels have the same shape, and that the respective second cross sections of the second confluence channels of the plurality of the second channels have the same shape.

This configuration prevents a case where a difference in the flow rate per unit time of the liquid mixture arises between the first confluence channels because of a difference in the shape of the first cross section and prevents also a case where a difference in the flow rate per unit time of the liquid mixture arises between the second confluence channels because of a difference in the shape of the second cross section.

It is preferable that the respective first confluence channels of the plurality of the first channels have a channel length, and all of the channel lengths of the respective first confluence channels are same, and that the respective second confluence channels of the plurality of the second channels have a channel length, and all of the channel lengths of the respective second confluence channels are same.

This configuration prevents a case where a difference in a flow time of the liquid mixture arises between the first confluence channels because of a difference in the channel length and prevents also a case where a difference in a flow time of the liquid mixture arises between the second confluence channels because of a difference in the channel length.

It is preferable that the first confluence channel of each of the plurality of the first channels has at least one first bent part and has a bent shape that causes the liquid mixture to change the flow direction at the first bent part, and that the respective first confluence channels of the plurality of the first channels have the same number of the first bent parts, that the second confluence channel of each of the plurality of the second channels has at least one second bent part and has a bent shape that causes the liquid mixture to change the flow direction at the second bent part, and that the respective second confluence channels of the plurality of the second channels have the same number of the second bent parts.

According to this configuration, because each first confluence channel has the bent shape bent at least at one first bent part, the channel length of each first confluence channel is made longer than the channel length in a case where each first confluence channel extends linearly as a whole, and because each second confluence channel has the bent shape bent at least at one second bent part, the channel length of each second confluence channel is made longer than the channel length in a case where each second confluence channel extends linearly as a whole. Because of this configuration, the flow time of the liquid mixture in each first confluence channel and each second confluence channel is made longer, and the channel capacity per unit volume of the channel structure is increased. In addition, the number of the first bent parts being the same in each first confluence channel prevents a case where a difference in the flow rate per unit time of the liquid mixture arises between the first confluence channels because of a difference in the number of the first bent parts, and the number of the second bent parts being the same in each second confluence channel prevents a case where a difference in the flow rate per unit time of the liquid mixture arises between the second confluence channels because of a difference in the number of the second bent parts.

As described above, the embodiment and modifications provide the channel device that, even when arrangement of the confluence portions in the channel structure restricts arrangement of the confluence channels connected to the confluence portions, can increase the channel capacity per unit volume of the channel structure.

This application is based on Japanese Patent application No. 2021-081871 filed in Japan Patent Office on May 13, 2021, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A channel device comprising:
a channel structure having therein a plurality of first channels and a plurality of second channels, the plurality of the first channels and the plurality of the second channels allowing a first liquid and a second liquid to join and flow through the first and second channels, respectively,
wherein each of the plurality of the first channels includes:
a first first-liquid introduction channel into which the first liquid is introduced;
a first second-liquid introduction channel into which the second liquid is introduced;
a first confluence portion connected to both a downstream end of the first first-liquid introduction channel and a downstream end of the first second-liquid introduction channel to cause the first liquid flowing through the first first-liquid introduction channel and the second liquid flowing through the first second-liquid introduction channel to join together; and
a first confluence channel connected to the first confluence portion on a downstream side of the first confluence portion to allow a liquid mixture of the first liquid and the second liquid having joined at the first confluence portion to flow through the first confluence channel,
each of the plurality of the second channels includes:
a second first-liquid introduction channel into which the first liquid is introduced;
a second second-liquid introduction channel into which the second liquid is introduced;
a second confluence portion connected to both a downstream end of the second first-liquid introduction channel and a downstream end of the second second-liquid introduction channel to cause the first liquid flowing through the second first-liquid introduction channel and the second liquid flowing through the second second-liquid introduction channel to join together; and
a second confluence channel connected to the second confluence portion on a downstream side of the second confluence portion to allow a liquid mixture of the first liquid and the second liquid having joined at the second confluence portion to flow through the second confluence channel,
the channel structure includes a plurality of first boards and a plurality of second boards, and the first board and the second board are stacked alternately along respective thickness directions of the first board and the second board,
each of the plurality of the first boards has a first board front surface and a first board back surface, and the first board front surface is one surface of the first board in the thickness direction of the first board while the first board back surface is the other surface opposite to the first board front surface,
each of the plurality of the second boards has a second board front surface and a second board back surface, and the second board front surface is one surface of the second board in the thickness direction of the second board, the one surface being in close contact with the first board back surface of the first board stacked on the second board, while the second board back surface is the other surface opposite to the second board front surface, the other surface being in close contact with the first board front surface of the first board on which the second board is stacked,
the first first-liquid introduction channels of the plurality of the first channels include a plurality of the first first-liquid introduction channels arranged along the first board front surface of each of the plurality of the first boards,
the first second-liquid introduction channels of the plurality of the first channels include a plurality of the first second-liquid introduction channels arranged along the first board front surface of each of the plurality of the first boards,
the first confluence channels of the plurality of the first channels include a plurality of the first confluence channels arranged along the second board front surface of each of the plurality of the second boards,
the first confluence portions of the plurality of the first channels in each of the first boards are configured of a plurality of first confluence portion through-holes that penetrate the first board in the thickness direction of the first board, and
the second first-liquid introduction channels of the plurality of the second channels and the second second-liquid introduction channels of the plurality of the second channels are arranged along the respective second board front surfaces of the plurality of the second boards, and are located in an area that is deviated from the plurality of the first confluence channels in a view in a direction along a stacking direction of the first board and the second board.

2. The channel device according to claim 1, wherein
the second confluence portions of the plurality of the second channels in each of the first boards are configured of a plurality of second confluence portion through-holes that penetrate the first board in the thickness direction of the first board,
the second confluence channels of the plurality of the second channels include a plurality of the second confluence channels arranged along the first board front surface of each of the plurality of the first boards, and
the plurality of the second confluence channels arranged along the first board front surface are located in an area that is deviated from the plurality of the first first-liquid introduction channels and the plurality of the first second-liquid introduction channels in a view in the direction along the stacking direction.

3. The channel device according to claim 2, wherein
the plurality of the first first-liquid introduction channels arranged along the first board front surface of each of the plurality of the first boards are configured of a plurality of first first-liquid introduction grooves formed on at least one of the first board front surface and the second board back surface in close contact with the first board front surface,
the plurality of the first second-liquid introduction channels arranged along the first board front surface of each of the plurality of the first boards are configured of a plurality of first second-liquid introduction grooves formed on at least one of the first board front surface and the second board back surface in close contact with the first board front surface,
the plurality of the first confluence channels arranged along the second board front surface of each of the plurality of the second boards are configured of a plurality of first confluence grooves formed on at least one of the second board front surface and the first board back surface in close contact with the second board front surface,
the plurality of the second first-liquid introduction channels arranged along the second board front surface of each of the plurality of the second boards are configured of a plurality of second first-liquid introduction grooves formed on at least one of the second board front surface and the first board back surface in close contact with the second board front surface,
the plurality of the second second-liquid introduction channels arranged along the second board front surface of each of the plurality of the second boards are configured of a plurality of second second-liquid introduction grooves formed on at least one of the second board front surface and the first board back surface in close contact with the second board front surface, and
the plurality of the second confluence channels arranged along the first board front surface of each of the plurality of the first boards are configured of a plurality of second confluence grooves formed on at least one of the first board front surface and the second board back surface in close contact with the first board front surface.

4. The channel device according to claim 3, wherein
the first first-liquid introduction groove constituting the first first-liquid introduction channel is provided on only one of the first board front surface and the second board back surface in close contact with the first board front surface,
the first second-liquid introduction groove constituting the first second-liquid introduction channel is provided on only one of the first board front surface and the second board back surface in close contact with the first board front surface,
the first confluence groove constituting the first confluence channel is provided on only one of the second board front surface and the first board back surface in close contact with the second board front surface,
the second first-liquid introduction groove constituting the second first-liquid introduction channel is provided on only one of the second board front surface and the first board back surface in close contact with the second board front surface,
the second second-liquid introduction groove constituting the second second-liquid introduction channel is provided on only one of the second board front surface and the first board back surface in close contact with the second board front surface, and
the second confluence groove constituting the second confluence channel is provided on only one of the first board front surface and the second board back surface in close contact with the first board front surface.

5. The channel device according to claim 2, wherein
the plurality of the first boards include a plurality of selected first boards that are selected out of the plurality of the first boards,
the first first-liquid introduction channels, the first second-liquid introduction channels, and the second confluence channels are arranged along the respective first board front surfaces of the plurality of the selected first boards in respective arrangement patterns, the respective arrangement patterns being equal to each other, and
the plurality of the selected first boards include at least one pair of adjacent first boards which are constituted by two of the selected first boards adjacent to each other in the stacking direction, and a specific number of boards are interposed between each of the at least one pair of the adjacent first boards, the specific number of boards being selected from the plurality of the first boards and the plurality of the second boards except for the selected first boards.

6. The channel device according to claim 5, wherein the first first-liquid introduction channels, the first second-liquid introduction channels, and the second confluence channels are arranged along the respective first board front surfaces of the plurality of the first boards in respective arrangement patterns, and all of the respective arrangement patterns are same.

7. The channel device according to claim 2, wherein
the plurality of the second boards include a plurality of selected second boards that are selected out of the plurality of the second boards,
the second first-liquid introduction channels, the second second-liquid introduction channels, and the first confluence channels are arranged along the respective second board front surfaces of the plurality of the selected second boards in respective arrangement patterns, the respective arrangement patterns being equal to each other, and
the plurality of the selected second boards include at least one pair of adjacent second boards which are constituted by two of the selected second boards adjacent to each other in the stacking direction, and a specific number of boards are interposed between each of the at least one pair of the adjacent second boards, the specific number of boards being selected from the plurality of the first boards and the plurality of the second boards except for the selected second boards.

8. The channel device according to claim 7, wherein the second first-liquid introduction channels, the second second-liquid introduction channels, and the first confluence channels are arranged along the respective second board front surfaces of the plurality of the second boards in respective arrangement patterns, and all of the respective arrangement patterns are same.

9. The channel device according to claim 1, wherein
the first first-liquid introduction channel has a first first-liquid inlet that allows the first liquid to flow into the first first-liquid introduction channel through the first first-liquid inlet,
the first second-liquid introduction channel has a first second-liquid inlet that allows the second liquid to flow into the first second-liquid introduction channel through the first second-liquid inlet,
the second first-liquid introduction channel has a second first-liquid inlet that allows the first liquid to flow into the second first-liquid introduction channel through the second first-liquid inlet,
the second second-liquid introduction channel has a second second-liquid inlet that allows the second liquid to flow into the second second-liquid introduction channel through the second second-liquid inlet,
the first first-liquid inlets of the plurality of the first channels are collectively arranged in a partial area of any given side surface selected from a plurality of side surfaces of the channel structure,
the first second-liquid inlets of the plurality of the first channels are collectively arranged in a partial area of any given side surface selected from the plurality of the side surfaces,
the second first-liquid inlets of the plurality of the second channels are collectively arranged in a partial area of any given side surface selected from the plurality of the side surfaces, and
the second second-liquid inlets of the plurality of the second channels are collectively arranged in a partial area of any given side surface selected from the plurality of the side surfaces.

10. The channel device according to claim 9, further comprising:
a first first-liquid distribution header attached to the channel structure so as to entirely cover the first first-liquid inlets of the plurality of the first channels to distribute the first liquid to the first first-liquid inlets of the plurality of the first channels;
a first second-liquid distribution header attached to the channel structure so as to entirely cover the first second-liquid inlets of the plurality of the first channels to distribute the second liquid to the first second-liquid inlets of the plurality of the first channels;
a second first-liquid distribution header attached to the channel structure so as to entirely cover the second first-liquid inlets of the plurality of the second channels to distribute the first liquid to the second first-liquid inlets of the plurality of the second channels; and
a second second-liquid distribution header attached to the channel structure so as to entirely cover the second second-liquid inlets of the plurality of the second channels to distribute the second liquid to the second second-liquid inlets of the plurality of the second channels.

11. The channel device according to claim 1, wherein
the first confluence channel has a first outlet that causes the liquid mixture to flow out, the liquid mixture flowing through the first confluence channel,
the second confluence channel has a second outlet that causes the liquid mixture to flow out, the liquid mixture flowing through the second confluence channel,
the first outlets of the plurality of the first channels are collectively arranged in a partial area of any given side surface selected from a plurality of side surfaces of the channel structure, and
the second outlets of the plurality of the second channels are collectively arranged in a partial area of any given side surface selected from the plurality of the side surfaces.

12. The channel device according to claim 11, further comprising:
a first recovery header attached to the channel structure so as to entirely cover the first outlets of the plurality of the first channels to receive and recover the liquid mixture flowing out of the first outlets; and
a second recovery header attached to the channel structure so as to entirely cover the second outlets of the plurality of the second channels to receive and recover the liquid mixture flowing out of the second outlets.

13. The channel device according to claim 1, wherein
the first confluence channels of the plurality of the first channels are configured such that respective flow rates per unit time of the liquid mixture in the first confluence channels are equal, and
the second confluence channels of the plurality of the first channels are configured such that respective flow rates per unit time of the liquid mixture in the second confluence channels are equal.

14. The channel device according to claim 13, wherein
the first confluence channel of each of the plurality of the first channels has a first cross section that is a cross section perpendicular to a flow direction of the liquid mixture in each first confluence channel, and the respective first cross sections of the first confluence channels have the same area, and
the second confluence channel of each of the plurality of the second channels has a second cross section that is a cross section perpendicular to a flow direction of the liquid mixture in each second confluence channel, and the respective second cross sections of the second confluence channels have the same area.

15. The channel device according to claim 14, wherein
the respective first cross sections of the first confluence channels of the plurality of the first channels have the same shape, and
the respective second cross sections of the second confluence channels of the plurality of the second channels have the same shape.

16. The channel device according to claim 13, wherein
the respective first confluence channels of the plurality of the first channels have a channel length, and all of the channel lengths of the respective first confluence channels are same, and
the respective second confluence channels of the plurality of the second channels have a channel length, and all of the channel lengths of the respective second confluence channels are same.

17. The channel device according to claim 13, wherein
the first confluence channel of each of the plurality of the first channels has at least one first bent part and has a bent shape that causes the liquid mixture to change the flow direction at the first bent part,
the respective first confluence channels of the plurality of the first channels have the same number of the first bent parts,
the second confluence channel of each of the plurality of the second channels has at least one second bent part and has a bent shape that causes the liquid mixture to change the flow direction at the second bent part, and
the respective second confluence channels of the plurality of the second channels have the same number of the second bent parts.
